(19) United States
(12) Patent Application Publication
(10) Pub. No.: US 2003/0035140 A1
(43) Pub. Date: Feb. 20, 2003

(54) Image processing apparatus, management unit, and program

(76) Inventors: Atsushi Tomita, Toyohashi-Shi (JP); Hideki Hino, Toyokawa-Shi (JP); Hideo Mae, Toyokawa-Shi (JP)

Correspondence Address: Platon N. Mandros, BURNS, DOANE, SWECKER & MATHIS, L.L.P, P.O. Box 1404, Alexandria, VA, 22313-1404, US

(21) Appl. No.: 10/218,595

(22) Filed: Aug. 15, 2002

(30) Foreign Application Priority Data
Aug. 17, 2001 (JP) 2001-248303

(51) Int. Cl. B41J 1/00; G06F 15/00

(52) U.S. Cl. 358/1.15

(57) ABSTRACT

When a management request transmission interval at which a request for management information is transmitted from a management terminal is shorter than a predictive time period that is predicted to be required for rewrite to firmware, i.e., when a request for management information is scheduled to be transmitted from the management terminal during the rewrite to firmware, a print controller transmits, to the management terminal, a request to change the management information request interval, and then, instructs an image processing apparatus to execute the rewrite to firmware by transmitting the firmware to the image processing apparatus.

This application is based on Patent Application No. 2001-248303 filed in Japan, the contents of which are hereby incorporated by reference.

### BACKGROUND OF THE INVENTION

(1) Field of the Invention

The present invention relates to an image processing apparatus, a management unit, and a program for executing a predetermined response process to a processing request of management information transmitted from a management terminal.

(2) Related Art

There are cases where an image processing apparatus is shared by a plurality of client terminals connected thereto via a LAN or the like. To such a network connecting a plurality of apparatuses, a management terminal is connected for the purpose of managing the entire network and each of the apparatuses. The management terminal regularly obtains, from the image processing apparatus, information about the image processing apparatus for the purpose of monitoring and managing the image processing apparatus (hereafter referred to as “management information”). Examples of such management information include information about a job status, a toner amount, the total number of print copies, a paper cassette, and the like.

On the other hand, the image processing apparatus stores, in its rewritable ROM, firmware for controlling basic operations of the apparatus. Examples of firmware include boot programs, control programs, and control data. Such firmware is not normally rewritten, but is occasionally required to be rewritten to improve performances of the image processing apparatus.

As one example, new firmware that is used to rewrite existing firmware is attached to an e-mail message by a terminal apparatus located at a service center of a maker, and the e-mail message is transmitted to an image processing apparatus of a rewrite target. Upon receipt of the e-mail message, the image processing apparatus obtains the new firmware, and rewrites the existing firmware to the obtained new firmware.

The image processing apparatus typically cannot execute other processes once it starts such rewrite of firmware. This is because an existing communication line for transmission and reception of control signals and other data is occupied as a communication line for transmission and reception of data used for the rewrite of firmware.

Also, due to the recent trend of an increased capacity of firmware, a processing time period required for rewrite to such large-capacity firmware is often longer than an interval at which a request for management information is transmitted. Accordingly, a request for management information may be transmitted to an image processing apparatus while the image processing apparatus is executing the rewrite to the firmware. It this happens, the following problem occurs.

Once the image processing apparatus starts the rewrite to the firmware, either the image processing apparatus cannot respond to a management information request transmitted from the management terminal, or the image processing apparatus delays a response to the request. Therefore, the management terminal ends up in repeatedly transmitting the management information request. This may increase the management processing load of the management terminal and the communication load of the network. Further, if no response is returned from the image processing apparatus for a long time, the management terminal may mistakenly judge that the image processing apparatus is out of order while the image processing apparatus is operating normally to execute the rewrite to the firmware. This represents a failure of the management terminal in properly managing the image processing apparatus.

Also, the above problem is not only limited to an image processing apparatus, but it may also occur to a management unit that is connected to the image processing apparatus and that executes a predetermined response process necessary for managing the image processing apparatus, in response to a processing request of management information transmitted from the management terminal.

### SUMMARY OF THE INVENTION

A first object of the present invention is to provide an image processing apparatus that can avoid such a case where a request for management information is transmitted from a management terminal to the image processing apparatus during rewrite of firmware.

A second object of the present invention is to provide a management unit that can avoid such a case where a request for management information necessary for managing an image processing apparatus is transmitted from a management terminal to the management unit while the image processing apparatus is executing rewrite of firmware.

A third object of the present invention is to provide a program that is executed by such an image processing apparatus.

The first object of the present invention is achieved by an image processing apparatus that executes a predetermined process in response to a request for management information that is transmitted from a management terminal, the image processing apparatus including: a memory storing firmware; an image processing job execution controller for executing an image processing job based on the firmware; a firmware obtaining unit for obtaining new firmware for a rewrite purpose; a firmware rewrite controller for rewriting the firmware stored in the memory to the obtained new firmware; and a notification controller for notifying the management terminal that transmission of the management information request is to be suspended while the firmware rewrite controller is rewriting the firmware stored in the memory to the obtained new firmware.

According to this construction, for example, the management terminal can suspend transmitting a processing request of management information when notified by the image processing apparatus that the transmission of the processing request is to be suspended. Therefore, the image processing apparatus is not given the processing request of management information from the management terminal during rewrite of firmware.

The second object of the present invention is achieved by a management unit that is connected to an image processing apparatus and that executes a predetermined process required for managing the image processing apparatus in response to a request for management information that is transmitted from a management terminal, the management unit including: an instruction controller for instructing the image processing apparatus to rewrite existing firmware to new firmware; and a notification controller for notifying the management terminal that transmission of the management information request is to be suspended while the image processing apparatus is rewriting the existing firmware to the new firmware.

According to this construction, for example, the management terminal can suspend transmitting a processing request of management information to the management unit when notified by the management unit that transmission of the processing request is not to be suspended. Therefore, the management unit is not given the processing request of management information from the management terminal while the image processing apparatus is executing rewrite of firmware.

The third object of the present invention is achieved by a program that is executed by a computer of an image processing apparatus for executing a predetermined process in response to a request for management information that is transmitted from a management terminal, the program including the steps of: obtaining firmware that is necessary for image processing; instructing to rewrite existing firmware to the obtained firmware; and notifying the management terminal that transmission of the management information request is to be suspended while the existing firmware is being rewritten to the obtained firmware.

According to this construction, the image processing apparatus is not given the processing request of management information from the management terminal during rewrite of firmware.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is an overall construction diagram including a user side system and a service center side system in an embodiment of the present invention;

FIG. 2 is a diagram showing a schematic section of an image forming apparatus in the embodiment of the present invention;

FIG. 3 is a diagram showing a circuit construction of the image forming apparatus in the embodiment of the present invention;

FIG. 4 is a diagram showing a circuit construction of a print controller in the embodiment of the present invention;

FIG. 5 is a diagram showing a circuit construction of a management apparatus in the embodiment of the present invention;

FIG. 6 is a diagram showing a circuit construction of a client apparatus in the embodiment of the present invention;

FIG. 7 is a diagram showing a circuit construction of a central management apparatus in the embodiment of the present invention;

FIG. 8 is a flowchart showing the operation of a CPU in the central management apparatus;

FIG. 9 is a diagram showing a content example of a register information table held by the central management apparatus;

FIG. 10 is a flowchart showing a firmware transmission process executed by the central management apparatus;

FIG. 11 is a diagram showing a message field of an e-mail message;

FIG. 12 is a flowchart showing the operation of a CPU in a management apparatus;

FIG. 13 is a diagram showing a content example of a register information table held by the management apparatus;

FIG. 14 is a flowchart showing the operation of a CPU in the print controller;

FIG. 15A is a diagram showing a content example of a job management table held by the print controller;

FIG. 15B is a diagram showing a content example of a firmware management table held by the print controller;

FIG. 16 is a flowchart showing a newly arrived e-mail checking process executed by the print controller;

FIG. 17 is a flow chart showing a job transmission process executed by the print controller;

FIG. 18 is a flowchart showing a firmware transmission process executed by the print controller;

FIG. 19 is a flowchart showing the operation of a control unit in an image forming apparatus;

FIG. 20 is a flow chart showing a firmware rewrite process executed by the image forming apparatus; and

FIG. 21 is a flowchart showing the firmware rewrite process executed by the image forming apparatus.

### DESCRIPTION OF THE PREFERRED EMBODIMENT

The following describes a preferred embodiment of an image processing apparatus relating to present invention, with reference to the drawings.

1. Overall Construction

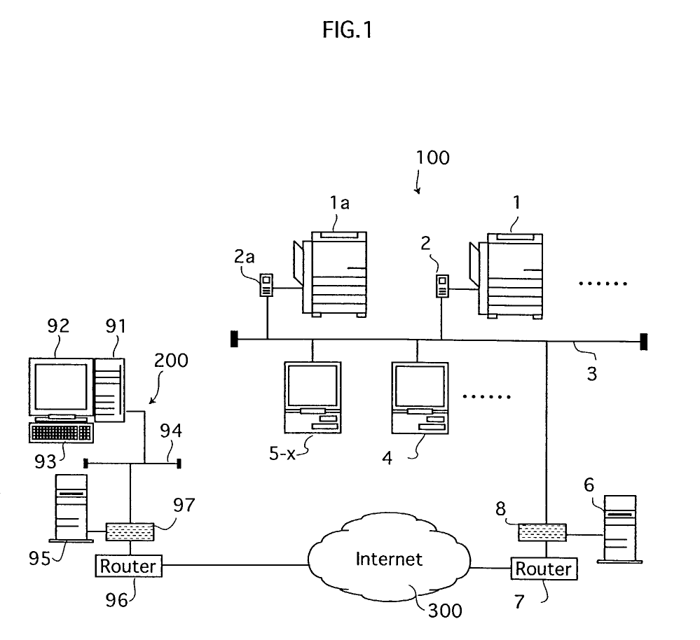

FIG. 1 is an overall schematic construction diagram showing a system 100 provided at a user side and a service system 200 provided at a service center side. The system 100 includes the image processing apparatus relating to the present invention. The service system 200 includes a central management apparatus 91 that centrally manages the image processing apparatus by remote operation. The following describes a case where the image processing apparatus relating to the present invention is applied to an image forming apparatus 1.

The system 100 at the user side includes a local area network (LAN) 3. The image forming apparatus 1 is connected the LAN 3 via a print controller 2. Because an image forming apparatus 1a and a print controller 2a respectively have the same constructions as the image forming apparatus 1 and the print controller 2, the following only describes the image forming apparatus 1 and the print controller 2.

The LAN 3 is connected to the Internet 300 via a router 7. A firewall 8 that restricts communication entering into the system 100 is connected to the router 7. The firewall 8 can function as a packet filtering, a proxy server, and the like. The firewall 8 permits a packet to pass only if a sender IP address, a recipient IP address, a sender port number, and a recipient port number satisfy predetermined conditions.

The service system 200 includes a LAN 94. The central management apparatus 91 is connected to the LAN 94. The LAN 94 is connected to the Internet 300 via a router 96. A firewall 97 that restricts communication entering into the service system 200 is connected to the router 96.

Also, a mail server 6 is connected to the LAN 3 of the system 100, and a mail server 95 is connected to the LAN 94 of the service system 200, so that services of collection and distribution of e-mail messages can be realized.

The central management apparatus 91 manages rewrite of firmware incorporated in, for example, the image forming apparatus 1, and so forth. When such rewrite of firmware becomes necessary, the central management apparatus 91 attaches firmware for a rewrite purpose to an e-mail message and transmits the e-mail message to the mail server 6 according to STMP (simple mail transfer protocol). It should be noted here that the firewalls 8 and 97 are set so as to permit communication under SMTP, i.e., an e-mail message, to pass therethrough.

In response to this, the print controller 2 downloads the e-mail message from the mail server 6, and obtains the firmware that has been attached to the e-mail message. The print controller 2 transmits the obtained firmware to the image forming apparatus 1, and also, instructs the image forming apparatus 1 to execute rewrite of existing firmware to the transmitted firmware.

Firmware is software incorporated in a ROM for controlling basic operations and the like of the image forming apparatus 1. Examples of firmware include programs and data that cannot be dynamically changed by a computer during computing, and programs and data that cannot be changed in environment settings made by a user. To be more specific, firmware may be a boot program, an input-output program, a control program, control data, and an OS, or may be an interpreter, a compiler, and a BIOS.

1) Construction of User Side System

The system 100 at the user side is constructed by connecting, in addition to the image forming apparatus 1, a management apparatus 4, a client apparatus 5-x, the mail server 6, the router 7, the firewall 8, and the like, to the LAN 3. It should be noted here that the constructions of the mail server 6, the router 7, the firewall 8, and the like, are as described above.

The image forming apparatus 1 forms an image by executing a print job, a copy job, and the like, that are descried later. For example, the image forming apparatus 1 receives a request for a print job from the client apparatus 5-x, and executes a print process.

The image forming apparatus 1 here is connected to the LAN 3 via the print controller 2. However, the image forming apparatus 1 may be equipped with the print controller 2 as being incorporated therein. In a broader sense, the image forming apparatus 1 may incorporate the print controller 2. Therefore, the “image forming apparatus” 1 referred to hereafter may intend to mean an image forming apparatus in which the print controller 2 is incorporated.

The management apparatus 4 manages the entire system 100. The management apparatus 4 regularly transmits, to the image forming apparatus 1, a request for information necessary for managing the image forming apparatus 1 (hereafter simply referred to as “management information”) via the print controller 2, and obtains the management information from the image forming apparatus 1. The management apparatus 4 then executes a predetermined management and monitoring process based on the obtained management information. Also, the management apparatus 4 transmits a request to change management information held by the image forming apparatus 1 regularly or irregularly, so as to make the image forming apparatus 1 set environments or execute requested processes. Also, the management apparatus 4 receives an event notification of an error transmitted from the print controller 2 when the error occurs in the image forming apparatus 1.

The print controller 2 manages a print job received from the client apparatus 5-x, obtains firmware that has been attached to an e-mail message transmitted from the central management apparatus 91 at the service center, transmits the obtained firmware to the image forming apparatus 1, and instructs the image forming apparatus 1 to rewrite existing firmware to the transmitted firmware. Also, the print controller 2 executes a management information response process of collecting management information, in response to a request for management information transmitted from the management apparatus 4, and transmitting the collected management information to the management apparatus 4.

1-1) Image Forming Apparatus and Management Apparatus

The image forming apparatus 1 and the management apparatus 4 use SNMP (simple network management protocol) that is a well-known communication protocol for a network management system. The print controller 2 and the image forming apparatus 1 operate as SNMP agents, and the management apparatus 4 operates as an SNMP manager.

Management information held by the image forming apparatus 1 as an SNMP agent is specified by MIB (management information base). In the present embodiment, the management information complies with the printer MIB (RFC1759) that is the Internet standard.

To the SNMP agent, the SNMP manager transmits a request for MIB, transmits an instruction to change the definition of MIB, and so forth. On the other hand, the SNMP agent transmits collected MIB to the SNMP manager and changes the definition of MIB, according to the request or the instruction transmitted from the SNMP manager. Also, the SNMP agent transmits an event notification to the SNMP manager when an event such as an error occurs in the SNMP agent.

The MIB management information can be roughly categorized as information about a network construction management, a user management, a traffic management, an error management, a security management, and the like. However, in the present embodiment, construction information, setting information, job management information, and the like, of the image forming apparatus 1 are also treated as management information.

Examples of the above construction information about the image forming apparatus 1 include a specification, an apparatus construction such as an address, types of options, an apparatus status indicating an overall status of the apparatus, such as ready, standby, sleep, busy, and the like, a toner amount, and the number of recording sheets in a paper cassette.

Examples of the above setting information include a recording sheet feed tray with high priority, a mode setting of an image processing mode (e.g., a two-sided printing, and an enlarged or reduced printing) and a parameter setting. Examples of the job management information include a job processing mode (for setting a job mode such as a job with high priority, a job with low priority, a job combination, and a job division), and a request for a job completion notification.

2) Construction of the Service System

The service system 200 is constructed by connecting, in addition to the central management apparatus 91, the mail server 95, the router 96, the firewall 97 and the like, to the LAN 94. It should be noted here the constructions of the mail server 95, the router 96, and the firewall 97 are as described above.

In the present embodiment, the system 100 and the service system 200 are connected to the Internet 300 via the routers 7 and 96 respectively. The communication protocol used is a combination of TCP/IP with SMTP that is for transmission and reception of e-mail messages.

It should be noted here that when an e-mail message is transmitted from the service center side to the user side, the mail server 95 at the service center side operates as an SMTP server, and the mail server 6 at the user side operates as a POP (post office protocol) server.

2. Construction of Each Apparatus

1) Image Forming Apparatus

1-1) Construction

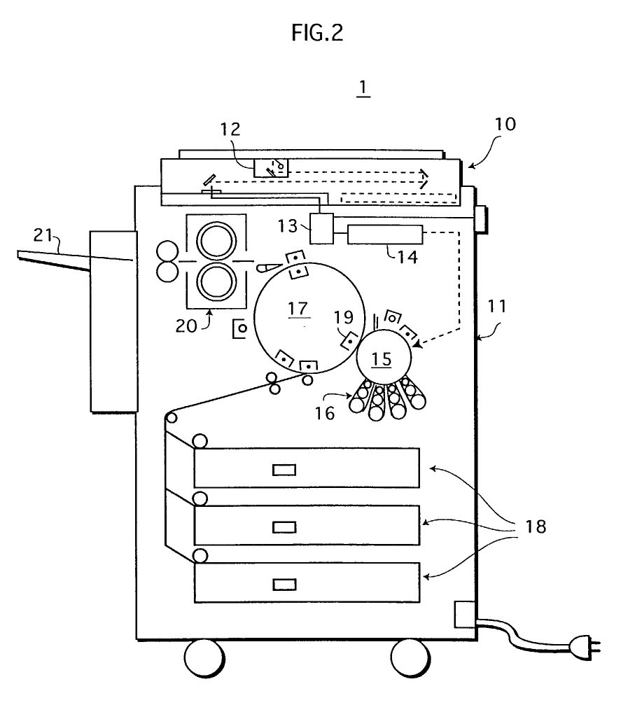

FIG. 2 is a diagram showing a schematic section of the image forming apparatus 1. As shown in the figure, the image forming apparatus 1 is a so-called multiple function peripheral (MFP).

The image forming apparatus 1 includes an image reading unit 10 and an image forming unit 11. The image reading unit 10 obtains image data by reading a document or the like. The image forming unit 11 forms an image based on the image data obtained by the image reading unit 10, or image data transmitted from the client apparatus 5-x via the LAN 3. It should be noted here that the image data transmitted form the client apparatus 5-x includes print data.

The image reading unit 10 is a well-known unit that reads an image of a document or the like placed on platen glass (not shown) by moving a scanner 12 having a CCD. Image data read by the image reading unit 10 is subjected to various data processing by a control unit 13, so as to be converted into processed image data.

The control unit 13 transmits the processed image data to a print head unit 14, and drives a laser diode incorporated in the print head unit 14 to expose a surface of a photoconductive drum 15, so as to form an electrostatic latent image on the surface of the photoconductive drum 15. A toner developing unit 16 is driven in synchronization with the rotation of the photoconductive drum 15 so as to develop the electrostatic latent image on the surface of the photoconductive drum 15.

On the other hand, a recording sheet in a paper cassette 18 is fed to a transfer drum 17 by an instruction transmitted from the control unit 13. The recording sheet is rolled up to the transfer drum 17. The toner image developed on the surface of the photoconductive drum 15 is transferred to the recording sheet by a transfer charger 19. The recording sheet is then detached from the surface of the transfer drum 17.

The toner image transferred to the recording sheet is easily detachable, and therefore, the toner is fixed onto the recording sheet surface by a fixing apparatus 20 heating and pressing the recording sheet. The recording sheet is then discharged onto a discharge tray 21.

In the image forming apparatus 1 with the above-described construction, a process of reading a document placed on the platen glass by a user in the image reading unit 10 and forming the image on a recording sheet is referred to as a “copy job”, and a process of forming a print image on a recording sheet based on image data received from each client apparatus 5-x is referred to as a “print job”.

1-2) Circuit Construction

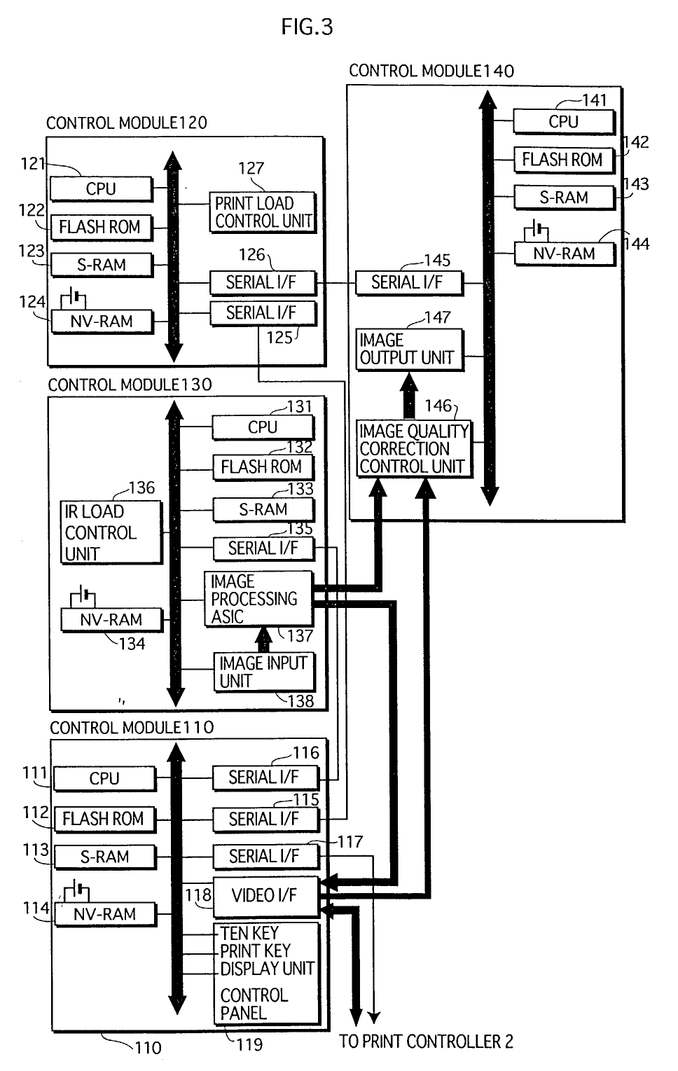

FIG. 3 is a diagram showing a circuit construction of the image forming apparatus 1. The control unit 13 of the image forming apparatus 1 includes, for example, four control modules 110, 120, 130, and 140 that are respectively responsible for an overall operation of the apparatus, a print process, an image reading process, and an image correction process. The control modules 110, 120, 130, and 140 are controlled by CPUs. It should be noted here that when a copy job, a print job, or the like, is executed, control signals and image data are transmitted and received among the corresponding control modules.

Here, each of the control modules 110, 120, 130, and 140 is a functional block that has a control function equipped with a control circuit including a CPU. The following describes each of the control modules 110, 120, 130, and 140.

1-2-1) Control Module 110

The control module 110 performs an overall control of the image forming apparatus 1. The control module 110 includes a CPU 111, a flash ROM 112, an S-RAM 113, and an NV-RAM 114, that are connected with one another by an internal bus.

The flash ROM 112 and the CPU 111 are placed physically close to each other. Because a high-speed communication line is used as an internal bus for the flash ROM 112 and the CPU 111, loading of a program into the CPU111 can be performed promptly at the time when power of the image forming apparatus 1 is turned on, and also, an influence of noise can be alleviated during loading of a program. It should be noted here that in each of the control modules 120, 130, and 140, the same internal bus is used and a flash ROM, and a CPU are placed physically close to each other.

The flash ROM 112 is a rewritable nonvolatile memory, and stores firmware that is executed by the control module 110. The CPU 111 performs an overall control of the image forming apparatus 1 according to the firmware stored in the flash ROM 112. The S-RAM 113 is a memory that provides a work area used when the CPU 111 executes the firmware. The NV-RAM114 is a memory that has a battery backup, and stores various set values to be used by the control module 110 performing various controls.

The control module 110 includes a serial I/F 115 and a serial I/F 116. The serial I/F 115 is used to transmit and receive control data to and from the control module 120. The serial I/F 116 is used to transmit and receive control data to and from the control module 130. The control module 110 is connected to the control module 120 and the control module 130 via serial cables.

The control module 110 includes a serial I/F 117 and a video I/F118. The serial I/F117 is used to transmit and receive control data to and from the print controller 2. The video I/F 118 is used to receive image data for a print job from the print controller 2.

The control module 110 includes a control panel 119 that is operated by a user. The control panel 119 includes a ten key, a PRINT key, a display unit, and the like. It should be noted here that a serial I/F stands for a serial interface.

Here, control data transmitted and received to and from each of the serial I/Fs 115 to 117 includes data used for generating and transmitting management information to the print controller 2 in response to a management information request transmitted from the management apparatus 4, and data of firmware for a rewrite purpose, and also includes control signals transmitted and received between the control module 110 and each of the other control modules 120 and 130. It should be noted here that the same applies to control data used in the other control modules 120, 130, and 140 that are described later.

1-2-2) Control Module 120

The control module 120 mainly controls a print process. The control module 120 includes a CPU 121, a flash ROM 122, an S-RAM 123, and an NV-RAM 124, that are connected with one another by an internal bus. The CPU 121 controls the print process according to firmware stored in the flash ROM 122. The S-RAM 123 and the NV-RAM 124 are substantially the same as those in the control module 110, and so are not described here.

The control module 120 includes a serial I/F 125 and a serial I/F 126. The serial I/F 125 is used to transmit and receive control data to and from the control module 110. The serial I/F 126 is used to transmit and receive control data to and from the control module 140. The control module 120 is connected to the control module 110 and the control module 140 via serial cables.

The control module 120 includes a print load control unit 127, and controls various drive loads such as a motor for the photoconductive drum 15 or the transfer drum 17, and a heater for the fixing apparatus 20.

1-2-3) Control Module 130

The control module 130 mainly controls a document image reading process. Like the control modules 110 and 120, the control module 130 includes a CPU 131, a flash ROM 132, an S-RAM 133, and an NV-RAM 134, that are connected with one another by an internal bus. The CPU 131 controls the image reading process according to firmware stored in the flash ROM 132. It should be noted here that the S-RAM 133 and the NV-RAM 134 are substantially the same as those in the control module 110, and so are not described here.

The control module 130 includes a serial I/F 135 for transmitting and receiving control data to and from the control module 110. The control module 130 is connected to the control module 110 via a serial cable.

The control module 130 includes an IR load control unit 136, an image input unit 138, and an image processing ASIC 137. The IR load control unit 136 drives and controls various drive loads such as a motor and a lamp in the image reading unit 10. The image input unit 138 obtains image data by scanning a document image on the platen glass and subjecting the image to photoelectric conversion by the CCD or the like, and outputs the image data to an image processing ASIC 137.

The image processing ASIC 137 subjects the image data input from the image input unit 138 to various image processing, to generate processed image data, and outputs the processed image data to the control module 140. Examples of image processing to be executed by the image processing ASIC 137 include shading correction, reflectance-density conversion, MTF correction, density correction, and error diffusion correction.

1-2-4) Control Module 140

The control module 140 mainly controls an image quality correction process. Like the control modules 110, 120, and 130 the control module 140 includes a CPU 141, a flash ROM 142, an S-RAM 143, and an NV-RAM 144, that are connected with one another by an internal bus. The CPU 141 controls the image quality correction process according to firmware stored in the flash ROM 142.

The control module 140 includes a serial I/F 145 for transmitting and receiving control data to and from the control module 120. The control module 140 is connected to the control module 120 via a serial cable. Also, the control module 140 is connected to the control module 110 and the control module 130 via an image quality correction control unit 146.

The image quality correction control unit 146 performs an image quality control on the processed image data output from the image processing ASIC 137 in the control module 130 and image data output from the control module 110. Here, the image quality control includes smoothing, halftone reproduction, and image correction.

The image output unit 147 drives a laser diode in the print head unit 14 so as to correspond to the image data output from the image quality correction control unit 146, to form an electrostatic latent image.

To rewrite firmware, the control module 110 transfers firmware data to targeted ones of the control modules 120, 130, and 140 using the serial I/Fs 115, 116, 125, 126, 135, and 145.

The serial I/Fs 115, 116, 125, 126, 135, and 145 are constructed to be suitable for a size of control data normally transmitted, and so have a small communication capacity per unit time. Accordingly, transferring large-capacity data such as firmware data using the serial I/Fs 115, 116, 125, 126, 135, and 145 requires a long time.

2) Print Controller

The print controller 2 manages print jobs received from the client apparatus 5-x, obtains firmware from an e-mail message transmitted from the central management apparatus 91, transmits the firmware to the image forming apparatus 1, instructs the image forming apparatus 1 to execute rewrite to the firmware, and transmits, to the management apparatus 4, information collected from the image forming apparatus 1 as management information in response to a management information request transmitted from the management apparatus 4. Besides these, when the print controller 2 obtains firmware, the print controller 2 transmits to the management apparatus 4, a request to change a time interval at which a management information request is transmitted (hereafter referred to as a “management information request interval”). This request to change the management information request interval aims at avoiding such a case where a management information request is transmitted from the management apparatus 4 while the image forming apparatus 1 is executing rewrite to the obtained firmware.

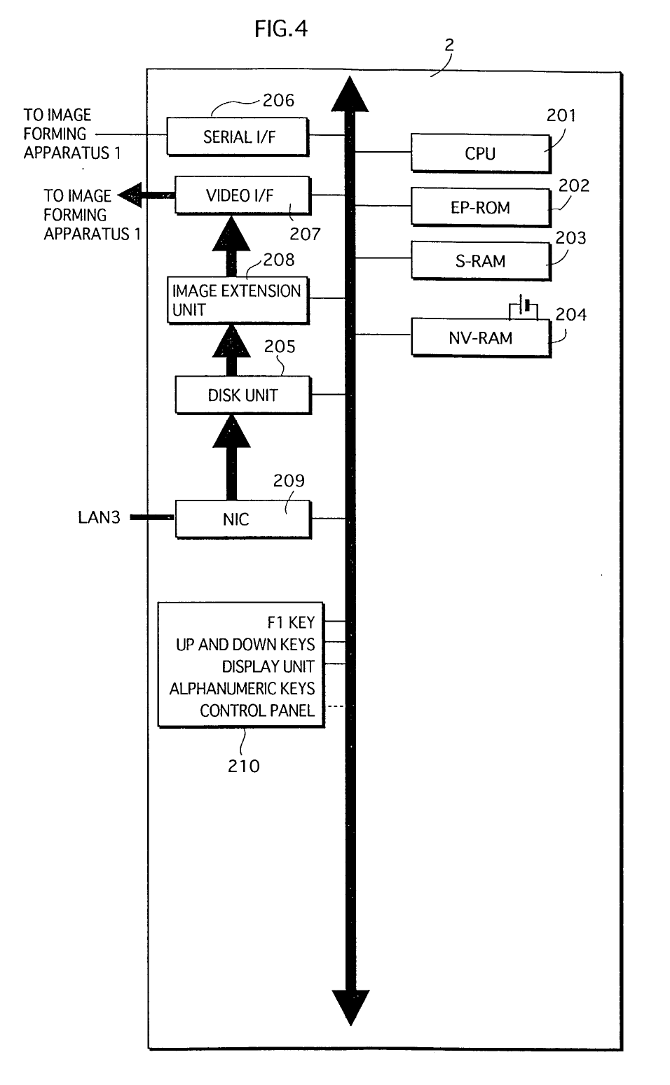

FIG. 4 is a block diagram showing a circuit construction of the print controller 2. The print controller 2 includes a CPU 201, an EP-ROM 202, an S-RAM 203, an NV-RAM 204, and a disk unit 205. The CPU 201 operates according to a program stored in the EP-ROM 202.

The print controller 2 is connected to the control module 110 in the image forming apparatus 1 via a serial I/F 206 and a video I/F 207, and to the LAN 3 via a network interface card (NIC) 209.

The print controller 2 includes a control panel 210. The control panel 210 has a display unit for displaying various setting information, information about a copy job (a size of a recording sheet, the number of copies, etc.), and the like. The control panel 210 also has various keys, such as up and down keys for moving a location of a cursor up and down on the display unit, selection keys (e.g., F1 to F4 keys) for selecting various functions, and alphanumeric keys.

The S-RAM 203 is a memory that provides a work area used when the CPU 201 executes a program. The NV-RAM 204 is a memory that has a battery backup, and stores data for communication setting and the like for communication with, for example, the client apparatus 5-x, the mail server 6, or the like.

The data for communication setting and the like includes an IP address and a mail account of the image forming apparatus 1, and an IP address and a password of the mail server 6. It should be noted here that although the present embodiment describes the case where an e-mail message forwarded to the image forming apparatus 1 is received by the print controller 2, an e-mail message may not be forwarded to the image forming apparatus 1 but may be directly forwarded to and received by the print controller 2.

The disk unit 205 stores various data, such as image data for a print job and data for firmware. The print controller 2 stores data for firmware into the disk unit 205 when obtaining the firmware from an e-mail message received from the central management apparatus 91. Also, the print controller 2 stores image data for a print job into the disk unit 205 when receiving the print job from the client apparatus 5-x.

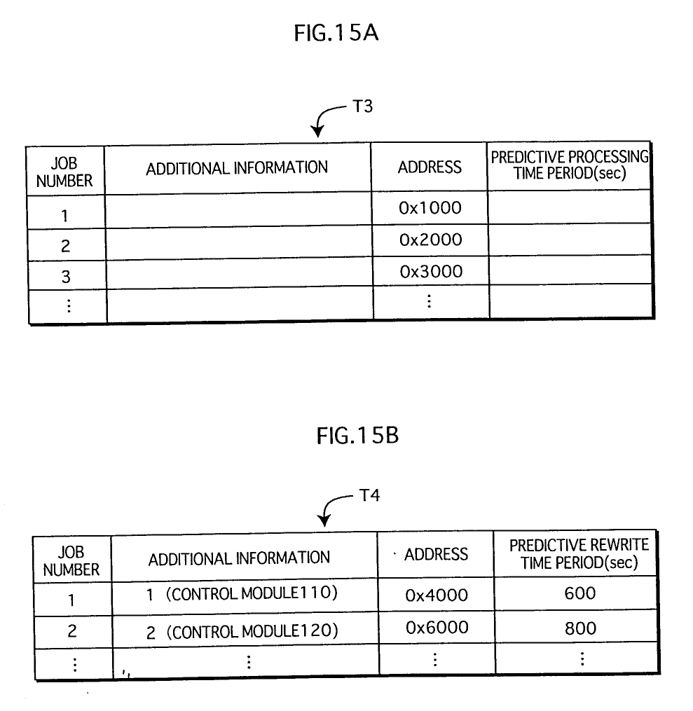

To manage print jobs, the print controller 2 registers a storage address in the disk unit 205 at which image data is stored, into a job management table T3 (see FIG. 15A) that is described later. To manage rewrite of firmware, the print controller 2 registers a storage address in the disk unit 205 at which data for firmware is stored, into a firmware management table T4 (see FIG. 15B) that is described later.

The image data stored in the disk unit 205 is written in page description language (PDL). The image extension unit 208 executes an extension process of converting such image data written in PDL into intermediate code and then converting the intermediate code, for example, into bitmap data. The extended image data is transmitted from the video I/F 207 to the image forming apparatus 1. At the same time, a control instruction relating to the image data is transmitted from the serial I/F 206 to the image forming apparatus 1.

Image data for a print job received by the print controller 2 or image data read by the image reading unit 10 in the image forming apparatus 1 is transmitted through a data bus that is capable of high-speed communication in the image forming apparatus 1, and an image based on the transmitted data is formed in the image output unit 147.

To be more specific, a communication line used from when image data for a print job or the like is received in the print controller 2 to when image data is input in the image output unit 147 in the image forming apparatus 1, namely, a communication line connecting the NIC 209, the image extension unit 208, the video I/F 207, the video I/F 118 in the control module 110, the image quality correction control unit 146 and the image output unit 147 in the control module 140 is realized by a data bus that is capable of high-speed communication.

Also, in the image forming apparatus 1, a communication line used from when a document image is read to when an image is output, namely, a communication line connecting the image input unit 138, and the image processing ASIC 137 in the control module 130 and the image quality correction control unit 146 and the image output unit 147 in the control module 140 is realized by a data bus that is capable of high-speed communication.

3) Management Apparatus

The management apparatus 4 is provided for managing the entire network. The management apparatus 4 manages the image forming apparatus 1 by transmitting a request for management information to the image forming apparatus 1, transmitting a request to change the contents of the manage information to the image forming apparatus 1, receiving an event notification from the image forming apparatus 1, and the like, via the print controller 2.

The management apparatus 4 receives a request for a management information request interval from the print controller 2, and then transmits the present management information request interval to the print controller 2. Also, the management apparatus 4 receives a request to change the present management information request interval to a new management information request interval, and then changes the present management information request interval to the new management information request interval.

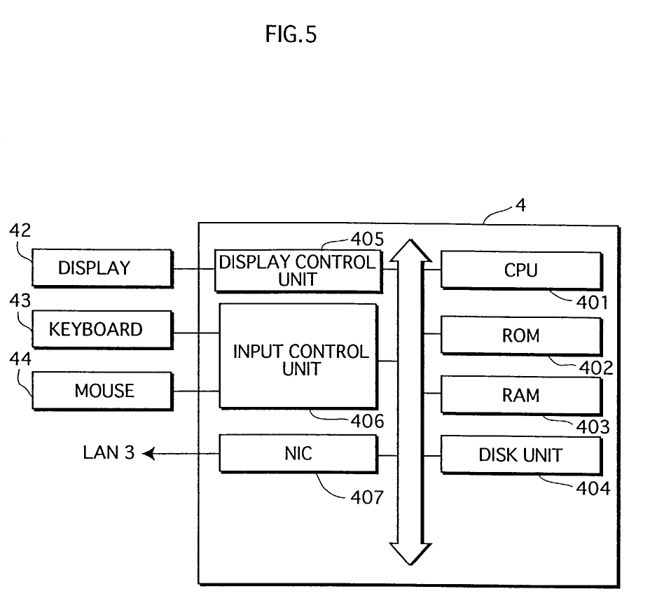

FIG. 5 is a block diagram showing a circuit construction of the management apparatus 4. The management apparatus 4 includes a CPU 401, a ROM 402, a RAM 403, and a disk unit 404. The CPU 401 operates according to a program stored in the ROM 402.

The management apparatus 4 is connected to the LAN 3 via an NIC 407. Via the LAN 3, the management apparatus 4 transmits a request for management information to the print controller 2, and receives management information, an event notification, and the like, from the print controller 2.

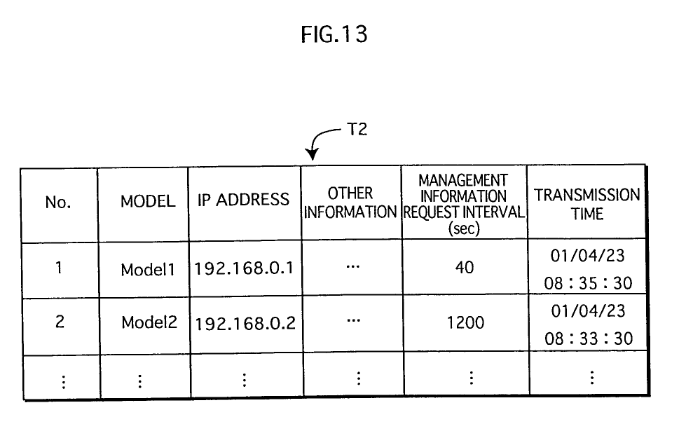

The disk unit 404 has a register information table T2 (see FIG. 13) that is described later in which register information of the image forming apparatus 1 managed by the management apparatus 4, a transmission time at which a management information request is transmitted, and the like are registered. The register information includes a model and an IP address of the image forming apparatus 1, a management information request interval at which a management information request is transmitted, and the like.

The management apparatus 4 includes a display control unit 405 and an input control unit 406. A display 42 is connected to the display control unit 405, and a keyboard 43 and a mouse 44 are connected to the input control unit 406. The keyboard 43 includes function keys (e.g., F1 to F10) for selecting various functions, alphanumeric keys for input of alphanumeric characters, and an enter key for entering an input.

4) Client Apparatus

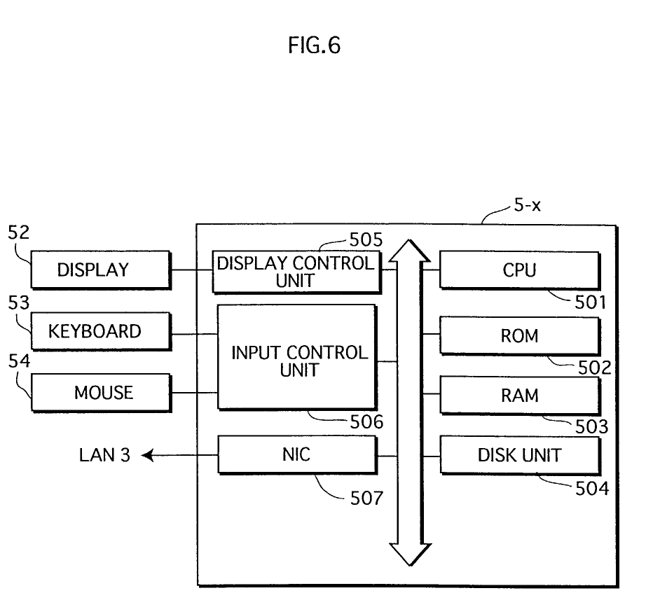

FIG. 6 is a block diagram showing a circuit construction of the client apparatus 5-x. The client apparatus 5-x is a personal computer or the like, and mainly requests a print job to the image forming apparatus 1. The client apparatus 5-x includes a CPU 501, a ROM 502, a RAM 503, a disk unit 504, a display control unit 505, and an input control unit 506.

The client apparatus 5-x is connected to the LAN 3 via an NIC 507, and transmits a print job to the print controller 2 via the LAN 3. It should be noted here that a display 52 is connected to the display control unit 505, and a keyboard 53 and a mouse 54 are connected to the input control unit 506.

5) Central Management Apparatus at the Service Center Side

The central management apparatus 91 generates an e-mail message according to an instruction by the operator when, for example, rewrite of firmware in the image forming apparatus 1 becomes necessary, attaches firmware for a rewrite purpose to the e-mail message, and transmits the e-mail message to which the firmware for a rewrite purpose is attached, to the image forming apparatus 1.

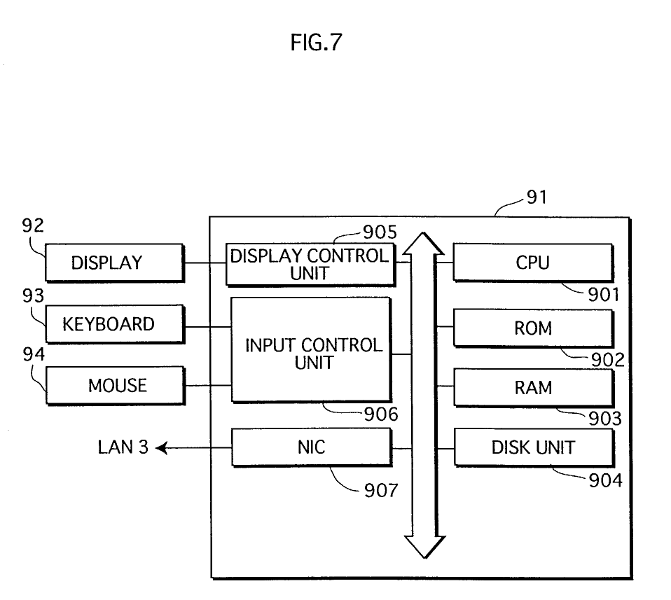

FIG. 7 is a block diagram showing a circuit construction of the central management apparatus 91. The central management apparatus 91 has a function of managing the image forming apparatus 1 at the user side. The central management apparatus 91 includes a CPU 901, a ROM 902 that stores programs to be executed by the CPU 901 and control data to be used by the CPU 901, a RAM 903, a disk unit 904, a display control unit 905, an input control unit 906, an NIC 907, and the like.

A display 92 is connected to the display control unit 905. A keyboard 93 and a mouse 94 are connected to the input control unit 906. The keyboard 93 has function keys (e.g., F1 to F10) for selecting various functions, alphanumeric keys for input of alphanumeric characters, an enter key for entering an input, and the like.

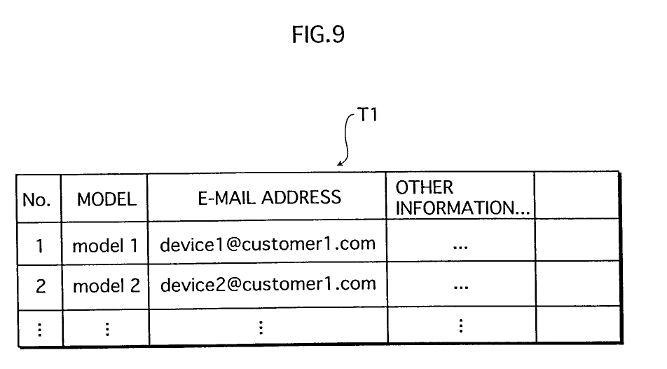

The disk unit 904 registers register information about the image forming apparatus 1 to be managed and the like into a register information table T1 (see FIG. 9) that is described later, and also, the disk unit 904 stores firmware for a rewrite purpose, and other data for the image forming apparatus 1. It should be noted here that a different folder (directory) is generated for each model and each of the control modules 110, 120, 130, and 140 of the image forming apparatus 1, and firmware for each model and each control module of the image forming apparatus 1 is stored in the corresponding folder. By doing so, firmware for a rewrite purpose to be attached to an e-mail message can be easily read from the disk unit 904.

3. Processing by Each Apparatus

1) Service Center Side

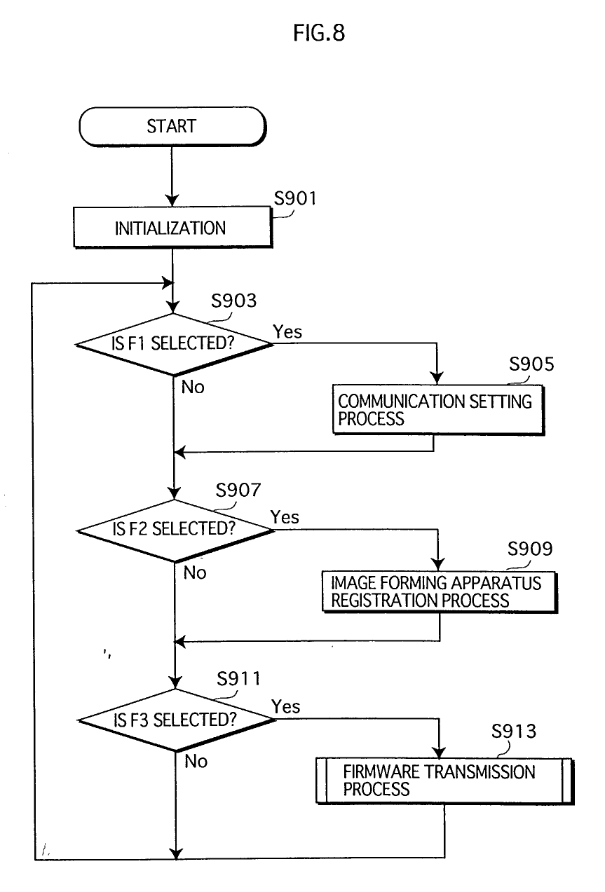

The following describes processing executed by the CPU 901 in the central management apparatus 91 at the service center side. FIG. 8 is a flowchart showing the operation of the CPU 901. First, the central management apparatus 91 starts processing when power is turned on by the operator, and executes a typical initialization process such as initialization of memories and parameters (step S901). Then, the CPU 901 judges whether F1 on the keyboard 93 is selected by the operator or not. When judging that F1 is selected, the CPU 901 executes a communication setting process (step S903;YES, step S905).

The communication setting process is to register communication setting used in the service system 200 at the service center. To be specific, the CPU 901 stores, in the disk unit 904, setting data input by the operator pressing alphanumeric keys etc., on the keyboard 93.

The contents of the communication setting include an IP address of the mail server 95 connected to the LAN 94 at the service center, an e-mail address of the central management apparatus 91, a password used to access the mail server 95, and the like.

In the case of “NO” in step S903, or when the communication setting process is completed in step S905, the CPU 901 judges whether F2 is selected by the operator or not. When judging that F2 is selected by the operator, the CPU 901 executes a registration process of an image forming apparatus at the user side (step S907;YES, step S909).

The registration process of the image forming apparatus is to register information about the image forming apparatus 1 managed by the central management apparatus 91. For example, a model and an e-mail address of the image forming apparatus 1, a name, an address, and the like, of the user, and other information are input by the operator pressing alphanumeric keys etc., on the key board 93, and so the input information is registered in the register information table T1 held by the disk unit 904.

FIG. 9 is a diagram showing an example content of the register information table T1. The register information table T1 includes a “model” field, an “e-mail address” field, and an “other information” field. Input register information from the operator is registered in each field of this table.

In the case of “NO” in step S907, or when the registration process of the image forming apparatus in step S909 is completed, the CPU 901 judges whether F3 is selected by the operator or not. When judging that F3 is selected, the CPU 901 executes a firmware transmission process (step S911;YES, step S913).

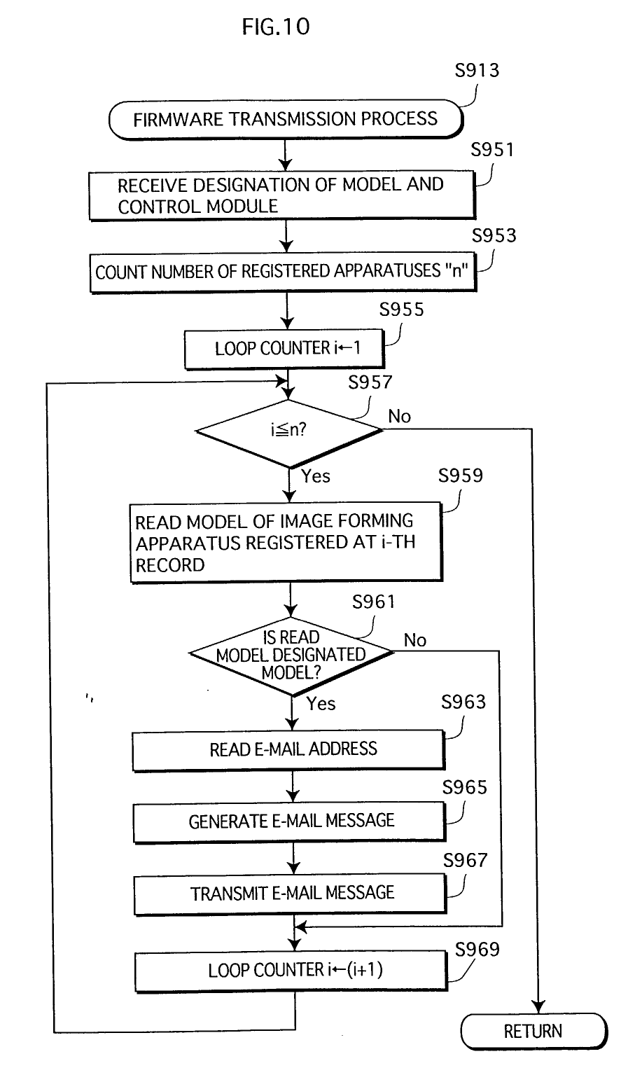

FIG. 10 is a flowchart showing the firmware transmission process. The following description refers to this figure. First, the CPU 901 receives a designation of a model and a rewrite target control module of the image forming apparatus 1 in which rewrite of firmware is necessary, by the operator operating the keyboard 93 or the mouse 94 (step S951). Here, the model and the control module of the image forming apparatus 1 are designated because firmware for the image forming apparatus 1 differs depending on its model and each control module.

Then, the CPU 901 counts the number “n” of image forming apparatuses 1 registered in the register information table T1 (see FIG. 9) held by the disk unit 904, and sets a loop counter “i” at 1 (steps S953 and S955).

In step S957, the CPU 901 compares a value of the loop counter “i” and the counted number of registered apparatuses “n”. When judging that the value of the loop counter “i” exceeds the number of registered apparatuses “n” (in the case of “NO”), the CPU 901 ends the processing. On the other hand, when judging that the value of the loop counter “i” is equal to or less than the number of registered apparatuses “n” in step S957 (in the case of “YES”), the CPU 901 reads a model of the image forming apparatus 1 from the i-th record of the register information table T1 (step S959).

The CPU 901 judges whether the read model of the image forming apparatus 1 matches a model designated by the operator or not (step S961). When judging that the read model matches the designated model, the CPU 901 reads an e-mail address of the image forming apparatus 1 from the i-th record of the register information table T1, and reads data for designated firmware from a folder provided for the designated model in the disk unit 904 (step S961;YES, step S963).

The CPU 901 generates an e-mail message by storing the read e-mail address into a header of a message field of an e-mail message and attaching the read firmware to a body of the message field (step S965).

The CPU 901 transmits the generated e-mail message to which the firmware is attached, to the image forming apparatus 1 (step S967), increments the loop counter “i” by one, and advances the processing to step S957. It should be noted here that TCP connection is established with the mail server 95 based on an IP address of the mail server 95, to transmit an e-mail message.

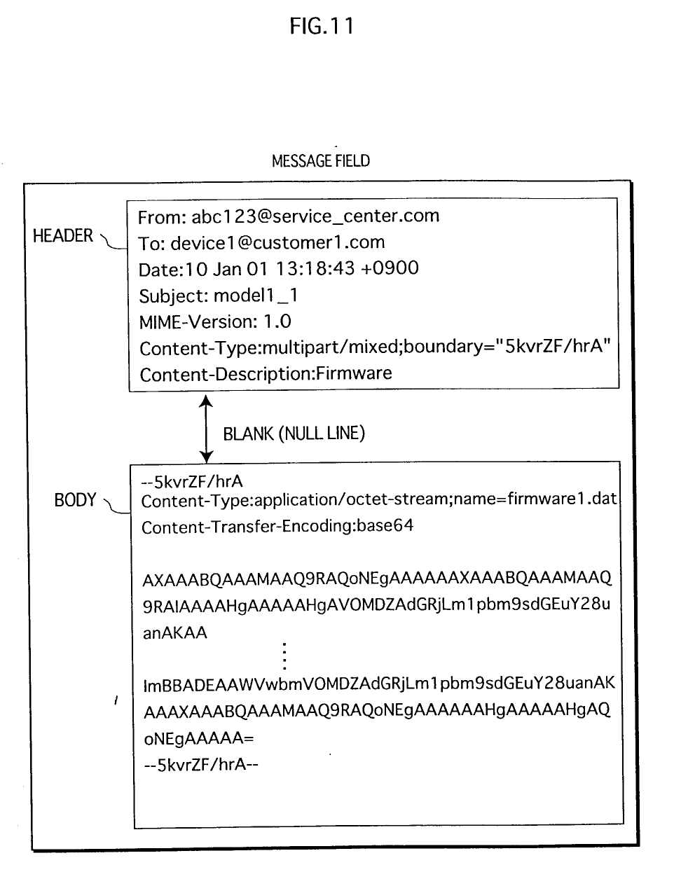

FIG. 11 shows a message field of an e-mail message transmitted from the central management apparatus 91. The following description refers to this figure. The message field of the e-mail message is divided into a header and a body by a NULL line according to the Internet standard (RFC822).

1-1) Header

The header includes a field “From” showing an e-mail address of a sender, a field “To” showing an e-mail address of a recipient, a field “Subject” showing a subject of a mail, a field “MIME-Version” showing the MIME (Multipurpose Internet MailExtensions) standard that is used to attach a file (firmware) in the MIME format, and the like.

In the field “Subject”, a model and a control module of the image forming apparatus 1 designated by the operator are written. For example, when the model is “model1” and a control module of a rewrite target is “control module 110”, a character string “model1_{—}1” is written in this field. In the field “Content-Description”, a character string “Firmware” indicating the content of a file attached to this e-mail message is written.

1-2) Body

In the body, firmware is stored in the MIME format. Firmware is usually binary data. However, RFC822 used in the present embodiment prohibits binary data from directly being written into a body of an e-mail message. Therefore, binary data is first converted into US-ASCII, and then is attached to an e-mail message.

Information about conversion of binary data is written in a field“Content-Type” and a field“Content-Transfer-Encoding” in the body. In the field “Content-Type”, a character string “application/octet-stream” indicating that firmware is binary data is written. In the field “Content-Transfer-Encoding”, a character string “base64” indicating a format used for the conversion into US-ASCII is written.

2) Management Apparatus

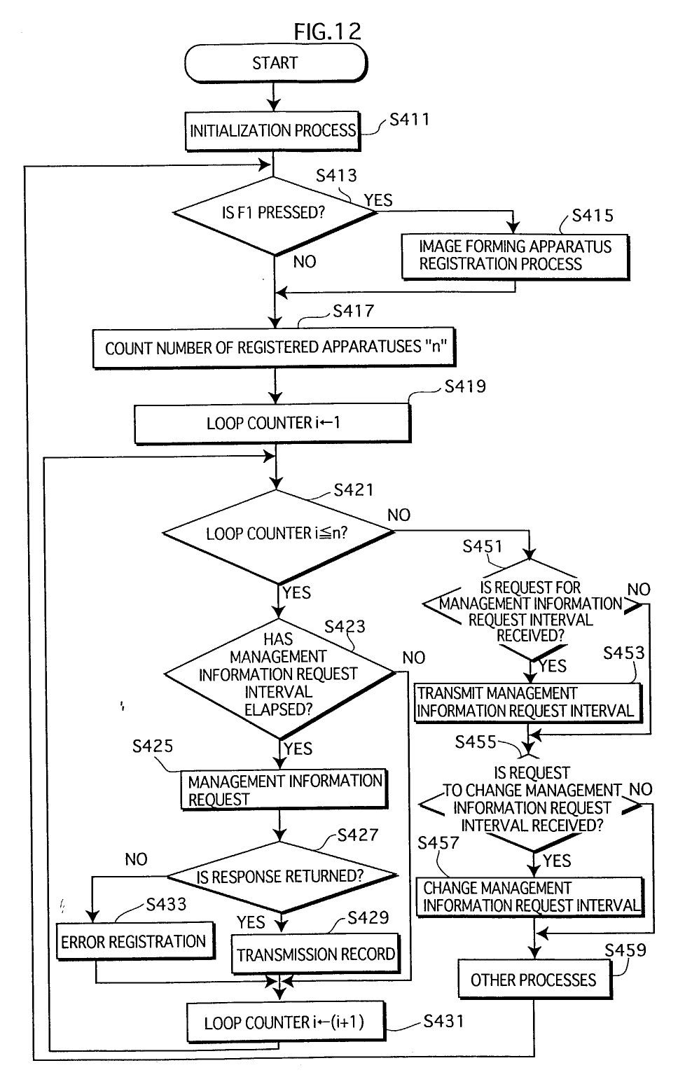

FIG. 12 is a flowchart showing the operation of the management apparatus 4. The following description refers to this figure. The CPU 401 starts processing when power is turned on by the operator or the like, and executes a typical initialization process such as initialization of memories and parameters (step S411). Then, the CPU 401 judges whether F1 on the keyboard 43 is pressed by the operator or not. When judging that F1 is pressed, the CPU 401 executes a registration process of an image forming apparatus (step S413;YES, step S415).

The registration process of the image forming apparatus is to register the image forming apparatus 1 managed by the management apparatus 4. To be specific, by the operator pressing alphanumeric keys etc., on the keyboard 43, a model and an IP address of the image forming apparatus 1, an interval at which a management information request is regularly transmitted to the image forming apparatus 1 (hereafter referred to as a “management information request interval”), and the like, are input, and the input information is registered in a register information table T2 held by the disk unit 404.

Here, the image forming apparatus 1 is registered in the registration process in step S415 by registering information about the image forming apparatus 1 at each user side input by the operator via the keyboard 43 in the register information table T2. Alternatively, the management apparatus 4 may automatically retrieve the image forming apparatus 1 that can function as an SNMP agent, and may register the retrieved image forming apparatus 1 in the register information table T2.

FIG. 13 is a diagram showing a content example of the register information table T2. The register information table T2 includes a “model” field, an “IP address” field, an “other information” field, a “management information request interval” field, and a “transmission time” field. In step S415 in FIG. 12, for example, a model “Model1”, an IP address “192.168.0.1”, and a management information request interval “40” may be input by the operator and may be each registered in the corresponding field in the register information table T2.

In step S413, when judging that F1 is not pressed by the operator (in the case of “NO”), or when completing the registration process of the image forming apparatus in step S415, the CPU 401 counts the number “n” of image forming apparatuses 1 registered in the register information table T2, and sets the loop counter “i” at 1 (steps S417 and S419).

In step S421, the CPU 401 compares a value of the loop counter “i” and the counted number “n” of registered apparatuses. When judging that the value of the loop counter “i” is equal to or less than the number “n” of registered apparatuses (in the case of “YES”), the CPU 401 judges whether a time period corresponding to a management information request interval has elapsed since a management information request has been previously transmitted to the image forming apparatus 1 registered at the i-th record of the register information table T2 or not (step S423).

Here, this judgment as to whether the time period corresponding to the management information request interval has elapsed or not is specifically performed as follows. First, an elapsed time period from the transmission time written in the register information table T2 in FIG. 13 to the present time is obtained. Then, a judgment is performed as to whether the elapsed time period is greater than the management information request interval written in the register information table T2 or not. It should be noted here that for a judgment as to whether a predetermined time period has elapsed or not, a timer that decrements the time period corresponding to the management information request interval as time elapses may be provided. In this case, this judgment as to whether a predetermined time period has elapsed or not can be performed by judging whether the timer shows “0” or not.

When judging that the time period corresponding to the management information request interval has not been elapsed, the CPU 401 increments the loop counter “i” by one (step S431), and advances the processing to step S421. On the other hand, when judging that the time period corresponding to the management information request interval has elapsed, the CPU 401 transmits a request for management information to the print controller 2 (step S423;YES, step S425). Then, the CPU 401 judges whether a response to the management information request is returned from the print controller 2 or not (step S427).

When judging that no response is returned from the print controller 2, the CPU 401 repeatedly transmits a management information request. When still judging that no response is returned from the print controller 2, the CPU 401 judges that the image forming apparatus 1 is out of order, and writes a message indicating an error occurrence into the “other information” field in the register information table T2 shown in FIG. 13 (step S427;NO, step S433).

When judging that a response is returned from the print controller 2 in step S427, the CPU 401 leaves a transmission record by updating the transmission time written in the register information table T2 to the time at which the management information request has been transmitted, obtains management information, stores the obtained management information into the disk unit 404, and increments the loop counter “i” by one (steps S429 and S431), and then, advances the processing to step S421.

In step S421, when judging that the value of the loop counter “i” is greater than the number of the registered apparatuses “n” (in the case of “NO”), the CPU 401 judges whether a request for a management information request interval is transmitted from the print controller 2 or not (step S451) . When judging that the request for management information request interval is transmitted from the print controller 2, the CPU 401 reads the present management information request interval from the register information table T2, and transmits the read management information request interval to the print controller 2 (step S451;YES, step S453) . When judging that a request for management information request interval is not transmitted (step S451;NO), the CPU 401 advances the processing to step S455.

Following this, in step S455, the CPU 401 judges whether a request to change a management information request interval is transmitted from the print controller 2 or not. When receiving such a request, the CPU 401 changes the management information request interval (e.g., 40) registered in the register information table T2 to a new management information request interval (e.g., 1200) designated together with the change request (step S455;YES, step S457), and advances the processing to step S459. When receiving no such request (step S455;NO), the CPU 401 advances the processing to step S459.

In step S459, the CPU 401 executes other processes. For example, the CPU 401 checks the presence of an error in the image forming apparatus 1 by analyzing management information obtained from the image forming apparatus 1, or transmits a request to change the contents of the management information to the image forming apparatus 1 according to a received event notification. When completing the other processes, the CPU 401 advances the processing to step S413.

3) Print Controller

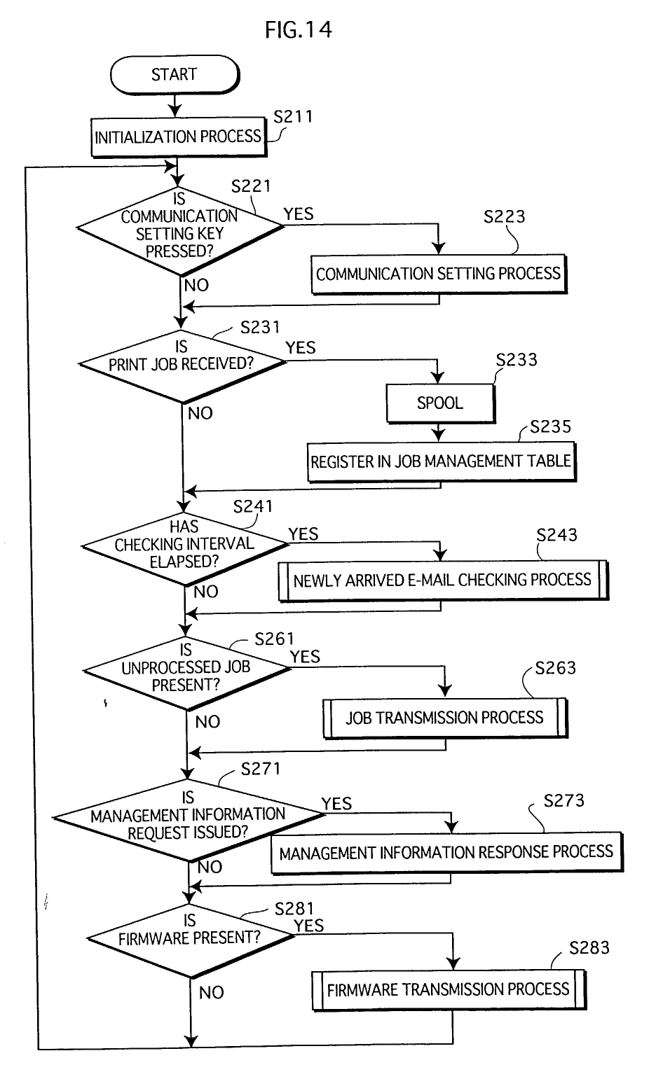

FIG. 14 is a flowchart showing the processing executed by the print controller 2. The following description refers to this figure. The CPU 201 starts processing when power is turned on by the operator or the like, and executes a typical initialization process such as initialization of memories and parameters (step S211).

The CPU 201 judges whether a communication setting key (e.g., F1 key) on the keyboard 93 is pressed by the operator or not (step S221). When judging that the communication setting key (F1 key) is pressed, the CPU 201 executes a communication setting process (step S221;YES, step S223). Here, the communication setting process is to register communication setting necessary for the print controller 2 to receive an e-mail message or the like. The communication setting process is described in detail later.

On the other hand, when judging that a communication setting (F1 key) is not pressed by the operator (step S221;NO), or when completing the process in step S223, the CPU 201 judges whether a print job is received from the client apparatus 5-x or not (step S231).

When judging that a print job is received, the CPU 201 spools the received print job, and registers the received print job at the last record of the job management table T3 (step S231;YES, steps S233 and S235). Here, image data for the print job is stored in the disk unit 205, and its storage address is registered in an “address” field in the job management table T3.

FIG. 15A is a diagram showing a content example of the job management table T3. The job management table T3 includes a “job number” field, an “additional information” field, an “address” field, and a “predictive processing time period” field. The “job number” field stores the numbering sequence showing the order in which each print job is received by the print controller 2.

When judging that no print job is received in step S231 in FIG. 14 (in the case of “NO”), or when completing the process in step SZ35, the CPU 201 judges whether an elapsed time period since the previous checking of a newly arrived e-mail message exceeds a time interval at which the presence of a newly arrived e-mail message is regularly checked (hereafter simply referred to as a “checking interval”) or not (step S241).

When judging that a checking interval has elapsed, the CPU 201 executes a newly arrived e-mail checking process (step S241;YES, step S243). The newly arrived e-mail checking process is to check whether a newly arrived e-mail message is present or not, obtain firmware, if attached thereto, from a newly arrived e-mail and register the firmware into the firmware management table T4, calculate a processing time period required for rewriting to the obtained firmware, and so forth. The newly arrived e-mail checking process is described in detail later.

FIG. 15B is a diagram showing a content example of the firmware management table T4. The firmware management table T4 includes a “job number” field, an “additional information” field, an “address” field, and a “predictive rewrite time period” field. The “job number” field shows the numbering sequence that indicates the order in which the print controller 2 has obtained attached firmware from an e-mail message.

In the “address” field, a storage address of data for firmware in the disk unit 205 is registered. The “predictive rewrite time period” field shows a processing time period that is predicted to be required for executing rewrite to the firmware. A predictive rewrite time period is calculated based on a size and the like of the firmware.

In the “additional information” field, “1” corresponds to the control module 110, “2” corresponds to the control module 120, “3” corresponds to the control module 130, and “4” corresponds to the control module 140.

On the other hand, when judging that a checking interval has not elapsed in step S241 (in the case of “NO”), or when completing the newly arrived e-mail checking process in step S243, the CPU 201 judges whether an unprocessed print job is present in the job management table T3 or not (step S261).

When judging that an unprocessed print job is present, the CPU 201 executes a job transmission process (step S261;YES, step S263). The job transmission process is to transmit an unprocessed print job to the image forming apparatus 1. The job transmission process is described in detail later. When judging that no unprocessed print job is present (step S261;NO), or when completing the job transmission process in step S263, the CPU 201 judges whether a request for management information is transmitted from the management apparatus 4 or not (step S271).

When judging that a management information request is transmitted, the CPU 201 executes a management information response process (step S271;YES, step S273). The management information response process is to transmit management information of the image forming apparatus 1 to the management apparatus 4 in response to the management information request transmitted from the management apparatus 4. The management information response process is described in detail later. When judging that no management information request is transmitted from the management apparatus 4 (step S271;NO), or when completing the management information response process in step S273, the CPU 201 judges whether firmware is present in the firmware management table T4 (see FIG. 15B) or not (step S281).

When judging that firmware is present, the CPU 201 executes a firmware transmission process (step S281;YES, step S283) This transmission process is to read firmware from the disk unit 205 and transmit the read firmware to the image forming apparatus 1, and instruct the image forming apparatus 1 to execute rewrite to the firmware. The firmware transmission process is described in detail later.

On the other hand, when judging that no firmware is registered in the firmware management table T4 (step S281;NO), or when completing the firmware transmission process in step S283, the CPU 201 advances the processing to step S221. The following describes each of the above-mentioned processes in more detail.

3-1) Communication Setting Process (step S223)

The communication setting process is to register communication setting that becomes necessary for the print controller 2 to transmit and receive e-mail messages. By the operator pressing alphanumeric keys provided in the control panel 210, an IP address of the mail server 6, an e-mail account of the image forming apparatus 1, and a password used to access the mail server 6, and also a checking interval and the like for checking regularly a newly arrived e-mail message forwarded to the image forming apparatus 1, are input, and are stored in the NV-RAM 204.

3-2) Newly Arrived E-mail Checking Process (step S243)

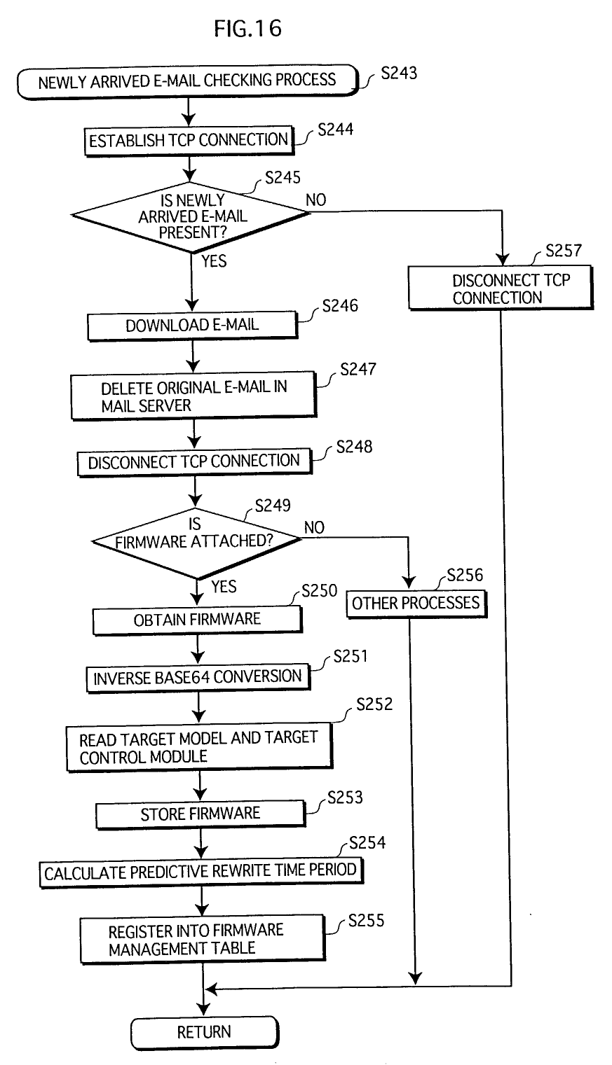

FIG. 16 is a flowchart showing the newly arrived e-mail checking process. The following description refers to this figure. This process is to check whether a newly arrived e-mail message forwarded to the image forming apparatus 1 is present or not, and if present, download the newly arrived e-mail message, and if firmware is attached to the newly arrived e-mail message, obtain the firmware.

First, the CPU 201 establishes TCP connection with the mail server 6 based on an IP address of the mail server 6 set and registered in advance in step S223, and checks whether a newly arrived e-mail message forwarded to the image forming apparatus 1 is present in the mail server 6 or not (steps S244 and S245).

When such a newly arrived e-mail message is present, the CPU 201 downloads the newly arrived e-mail message, and deletes the corresponding original e-mail message kept in the mail server 6, and then disconnects TCP connection that has been established with the mail server 6 (step S245,4YES, steps S246, S247, and S248). On the other hand, when no such newly arrived e-mail message is present in step S245, the CPU 201 disconnects TCP connection with the mail server 6, and ends the process (step S245;NO, step S257).

Following this, the CPU 201 judges whether firmware is attached to the downloaded e-mail message or not. This judgment is performed by judging whether a field body of the field “Content-Description” in the header of the e-mail message contains a character string “Firmware” as shown in FIG. 11.

When judging that firmware is attached to the downloaded e-mail message, the CPU 201 obtains data written in US-ASCII characters into which firmware has been converted, from the body of the message field of the e-mail message. The CPU 201 then subjects the obtained data to the inverse Base 64 conversion, so as to obtain the firmware in the form of binary data (step S249;YES, steps S250 and S251).

Following this, the CPU 201 reads a model of a firmware rewrite target and a target control module number from the field body of the field “Subject” in the header of the e-mail message, and stores the firmware in the form of binary data into the disk unit 205 (steps S252 and S253).

Then, the CPU 201 calculates a predictive rewrite time period that is a processing time period predicted to be required for the rewrite to the firmware (step S254). To be more specific, the CPU 201 calculates a data size of the firmware. Then, the CPU 201 multiplies the calculated data size by a rewrite time per unit size, to obtain a rewrite time period. The predictive rewrite time can be obtained by adding the calculated rewrite time period, a standard initialization time period required for initialization by rebooting the image forming apparatus 1 after the rewrite to the firmware, and an extra time period for possible errors of the actual rewrite to the firmware.

To sum up, the predictive rewrite time period can be calculated by the following equation.

Predictive rewrite time period=rewrite time period+initialization time period+extra time period,

where rewrite time period=firmware size×rewrite time per unit size

It should be noted here that the extra time period is set in advance as approximately several minutes, and is registered together with the rewrite time per unit size and the initialization time period in the communication setting process in step S223 in FIG. 14.

Next, the CPU 201 registers information about firmware that has been subjected to the inverse Base64 conversion, at the last record of the firmware management table T4 (step S255).

To be more specific, the CPU 201 registers a storage address of the firmware in the disk unit 205 into the “address” field, a calculation result of the predictive rewrite time period into the “predictive rewrite time period” field, and a target control module number into the “additional information” field. Then, the CPU 201 ends the process.

When judging that no firmware is attached to the downloaded newly arrived e-mail message in step S249 (in the case of “NO”), the CPU 201 executes a process for a purpose other than a firmware rewrite purpose (step S256), and ends the process.

It should be noted here that although in the newly arrived e-mail checking process one e-mail message is downloaded at everytime when TCP connection is established even if a plurality of newly arrived e-mail messages are present. However, for example, a plurality of newly arrived e-mail messages may be downloaded at one time and a judgment may be performed for each of the newly arrived e-mail messages as to whether firmware is attached thereto or not after the TCP connection is disconnected.

3-3) Job Transmission Process (step S263)

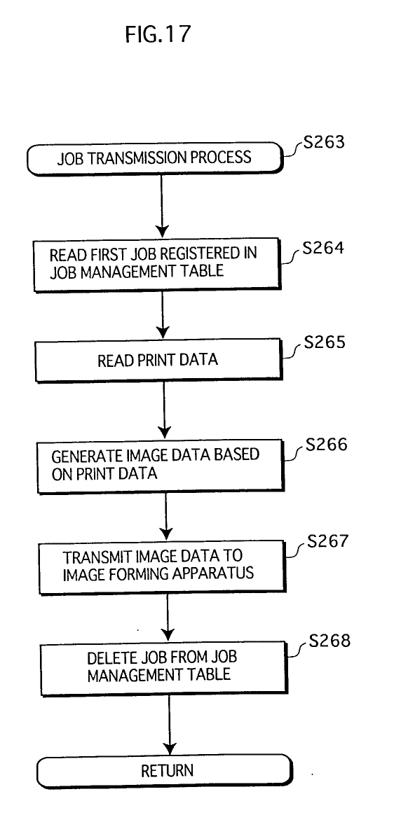

FIG. 17 is a flowchart showing the job transmission process. The following describes the job transmission process, with reference to this figure. First, the CPU 201 reads a print job registered at the first record of the job management table T3 (step S264).

The CPU 201 reads image data for the read print job (print image data written in PDL) from the disk unit 205 based on an address written in the job management table T3, and makes the image extension unit 208 extend the read image data to generate image data (bitmap data). The CPU 201 then transmits the image data to the image forming apparatus 1 via the video I/F 207. At the same time, the CPU 201 transmits control data for the print job to the control module 110 via the serial I/F 206 (steps S265, S266, and S267).

When completing transmission of the image data to the image forming apparatus 1, the CPU 201 deletes the print job registered at the first record of the job management table T3 (step S268), and ends the process. It should be noted here that when the first print job is deleted, the numbering sequence of each of the other print jobs that follow is advanced by one position.

3-4) Management Information Response Process (step S273)

The management information response process is to analyze control information collected from each of the control modules 110, 120, 130, and 140 in the image forming apparatus 1 in response to a management information request transmitted from the management apparatus 4, generate management information, and transmit the generated management information to the management apparatus 4. Also, when a request to change the definition of the management information is transmitted from the management apparatus 4, the CPU 201 instructs to change the definition of the management information stored in the NV-RAM 204, instructs the image forming apparatus 1 to change the definition of the management information, and also, transmits a message indicating that the print controller 2 or the image forming apparatus 1 has completed to change the definition of the management information, to the management apparatus 4.

3-5) Firmware Transmission Process (step S283)

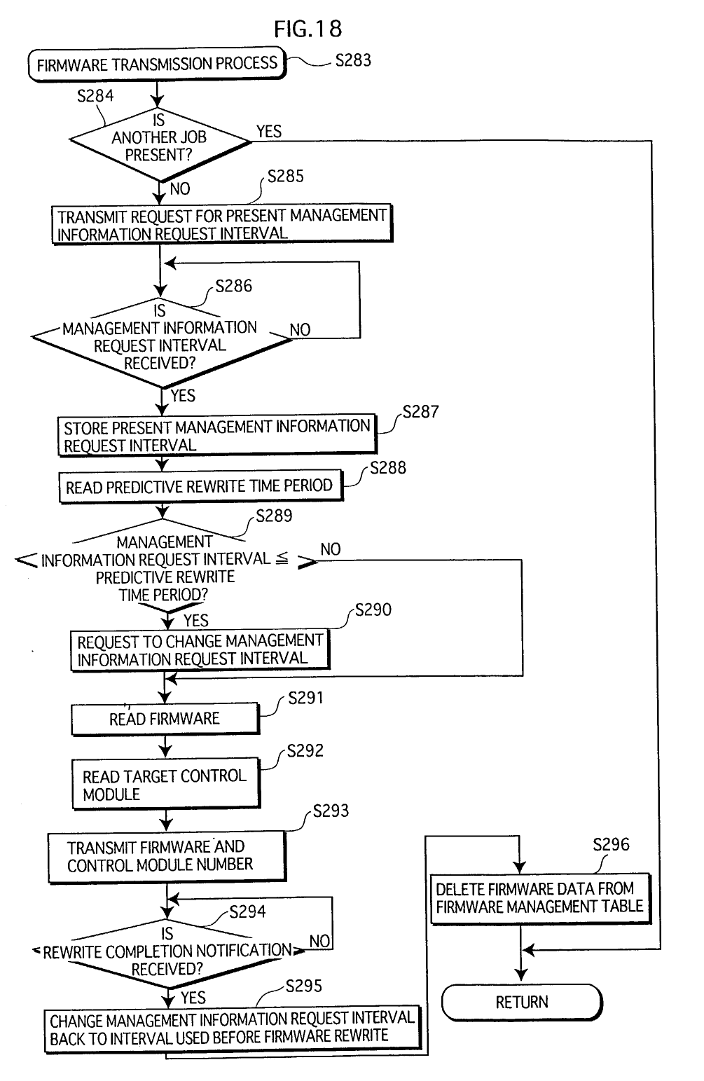

FIG. 18 is a flowchart showing the firmware transmission process. The following describes the firmware transmission process, With reference to this figure. First, in step S284, the CPU 201 judges whether the image forming apparatus 1 is presently executing a copy job or not.

When judging that the image forming apparatus 1 is not presently executing a copy job, the CPU 201 transmits, via the LAN β, a request for the present management information request interval, to the management apparatus 4 (step S284;NO, step S285) In response to this, the management apparatus 4 transmits a management information request interval written in the register information table T2 by executing the request interval transmission process (step S453 in FIG. 12).

The print controller 2 receives the present management information request interval from the management apparatus 4, and stores the received management information request interval into the disk unit 205. Then, the print controller 2 reads a predictive rewrite time period of firmware registered at the first record of the firmware management tablet T4 (see FIG. 15B) (step S286;YES, steps S287 and S288).

Following this, the CPU 201 judges whether the present management information request interval is equal to or less than the predictive rewrite time period, by comparing the present management information request interval and the predictive rewrite time period (step S289).

When judging that the present management information request interval is equal to or less than the predictive rewrite time period (in the case of “YES”), the CPU 210 judges that a management information request is scheduled to be transmitted from the management apparatus 4 while the image forming apparatus 1 is executing rewrite to the firmware. Therefore, the CPU 201 transmits, to the management apparatus 4, a request to change the present management information request interval (step S289;YES, step S290).

Changing a management information request interval here intends to mean changing the present management information request interval to a new management information request interval that is equal to or greater than the predictive rewrite time period. To be more specific, the new management information request interval is determined as the predictive rewrite time period being rounded up in units of ten minutes. For example, when the predictive rewrite time period is 14 minutes, the CPU 201 transmits, to the management apparatus 4, a request to change the present management information request interval to 20 minutes, i.e., 1200 sec.

Following this, the CPU 201 reads data for firmware from the disk unit 205 based on an address written in the firmware management table T4, and reads a control module number of a firmware rewrite target from the “additional information” field (steps S291 and S292).

The CPU 201 then transmits the read data for firmware and the control module number of the rewrite target to the control module 110 in the image forming apparatus 1 via the serial I/F 206 (step S293) . It should be noted here that because the image forming apparatus 1 starts a firmware rewrite process upon receipt of data for firmware, transmission of the data for firmware is equivalent to issuing an instruction to the image forming apparatus 1 to execute rewrite to the firmware.

In step S294, the CPU 201 receives a message indicating that the firmware rewrite process is completed, from the image forming apparatus 1. When the initialization timing at which the image forming apparatus 1 is to be rebooted and initialized comes after the reception of such a message, the CPU 201 transmits, to the management apparatus 4, a request to change the new management information request interval written in the register information table T2 back to the management information request interval used before the rewrite to the firmware (step S294;YES, step S295).

To be more specific, the CPU 201 transmits, to the management apparatus 4, a request to change the new management information request interval to the management information request interval recorded in step S287. Due to this, once the image forming apparatus 1 completes rewrite to the firmware, the management apparatus 4 changes the management information request interval back to the management information request interval used before the rewrite to the firmware, and thereafter, transmits a management information request to the print controller 2 at every normal management information request interval.

Then, the CPU 201 deletes the first firmware registered in the firmware management table T4 (step S296), and ends the process. The deletion of the firmware from the firmware management table T4 results in the numbering sequence of other firmware that follows therein is advanced by one position.

On the other hand, in step S284, when judging no other copy job is present, the CPU 201 returns the processing to step S283 in FIG. 14. Also, in step S289, when judging that the management information request interval is greater than the predictive rewrite time period, i.e., a management information request is not scheduled to be transmitted from the management apparatus 4 while the image forming apparatus 1 is executing rewrite to the firmware, the CPU 201 advances the processing to step S291.

4) Image Forming Apparatus

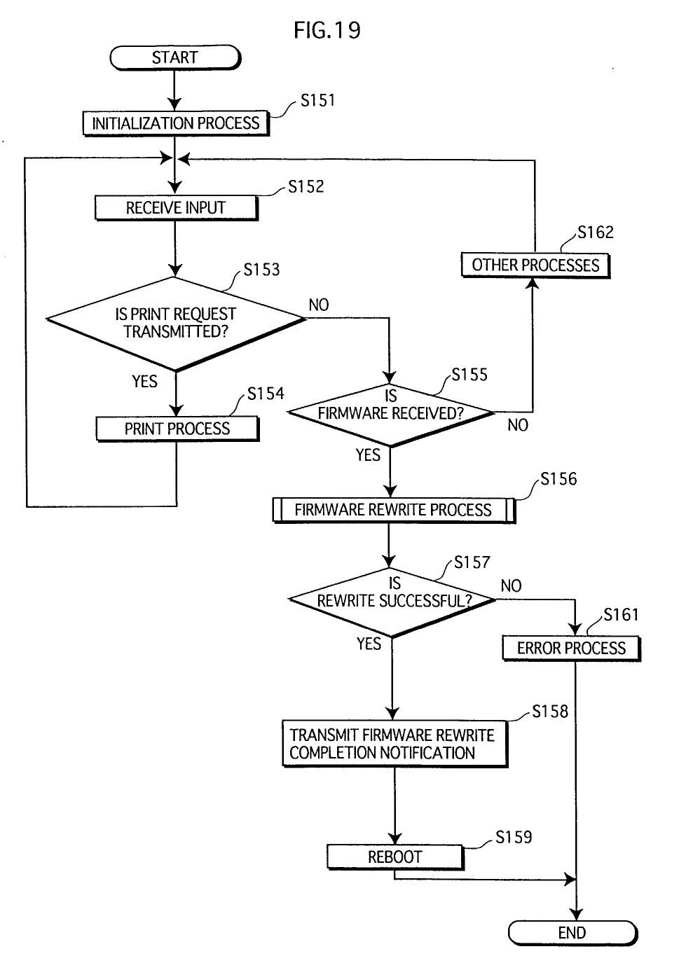

FIG. 19 is a flowchart showing the operation of the control unit 13 in the image forming apparatus 1. The following description refers to this figure. The CPU 111 starts processing when power is turned on by the operator or the like, and executes a typical initialization process such as initialization of memories and parameters in the control modules 110, 120, 130, and 140 (step S151).

The CPU 111 executes a reception process of receiving various signals at once, including signals indicating a print job and a copy job. Examples of various signals include input signals by various key operations of the control panel 119 of the image forming apparatus 1, control signals transmitted from sensors controlled by the control modules 120, 130, and 140, signals for event notifications transmitted from the control modules 110, 120, 130, and 140, control signals and data relating to a print job request, a firmware rewrite instruction, and a management information request transmitted from the print controller 2 via the serial I/F 117 or the video I/F 118.

Upon receipt of these signals, the CPU 111 judges, as to each of the signals, whether the signal indicates a print request or not (step S153). A print request is such a request to form an image by a copy job placed by a user setting a document image in the image input unit 138 and pressing the PRINT key on the control panel 119, or by a print job transmitted from the client apparatus 5-x.

When judging that the signal indicates a print request, the CPU 111 makes a print process executed by the corresponding control module 110, 120, 130, or 140. When completing the print process (step S153;YES, step S154), the CPU 111 advances the processing to step S152.

In step S153, when the signal does not indicate a print request, the CPU 111 judges whether the signal indicates firmware or not (stepS155). When judging that the signal does not indicate firmware, the CPU 111 executes other processes, e.g., the CPU 111 makes a management information generation process executed by the control modules 110, 120, 130, and 140 (step S155;NO, step S162), and advances the processing to step S152.

When judging that the signal indicates firmware, the CPU 111 executes a firmware rewrite process (step S155;YES, step S156). It should be noted here that the firmware rewrite process is descried later. After completing the firmware rewrite process, the CPU 111 judges whether the rewrite to the firmware is successful or not (step S157). This judgment as to whether the rewrite to the firmware is successful or not is performed by comparing a checksum C1 before the rewrite to the firmware and a checksum C2 after the rewrite to the firmware that are described later. To be more specific, the rewrite to the firmware is judged as successful when the checksum C1 is equal to the checksum C2.

When judging that the rewrite to the firmware is successful, the CPU 111 transmits a message indicating that the firmware rewrite process has been completed, to the print controller 2 (step S158). Then, the CPU 111 quits programs executed in the other control modules 120, 130, and 140, reboots the image forming apparatus 1 (step S159), and again executes a typical initialization process including initialization of memories and parameters in the control modules 110, 120, 130, and 140 (step S151). The CPU 111 then advances the processing to a next step.

On the other hand, when judging that the rewrite to the firmware is not successful, the CPU 111 executes an error process, and ends the processing (step S157;NO, step S161). This error process may be to make a display unit in the control panel 119 display a message, for example, showing “XXX error has occurred. Please contact service center.”, and to only accept a predetermined operation by a manager.

It should be noted here that when the rewrite to the firmware is not successful, an error process may not be executed immediately but may be executed after the rewrite to the firmware is retried and fails again.

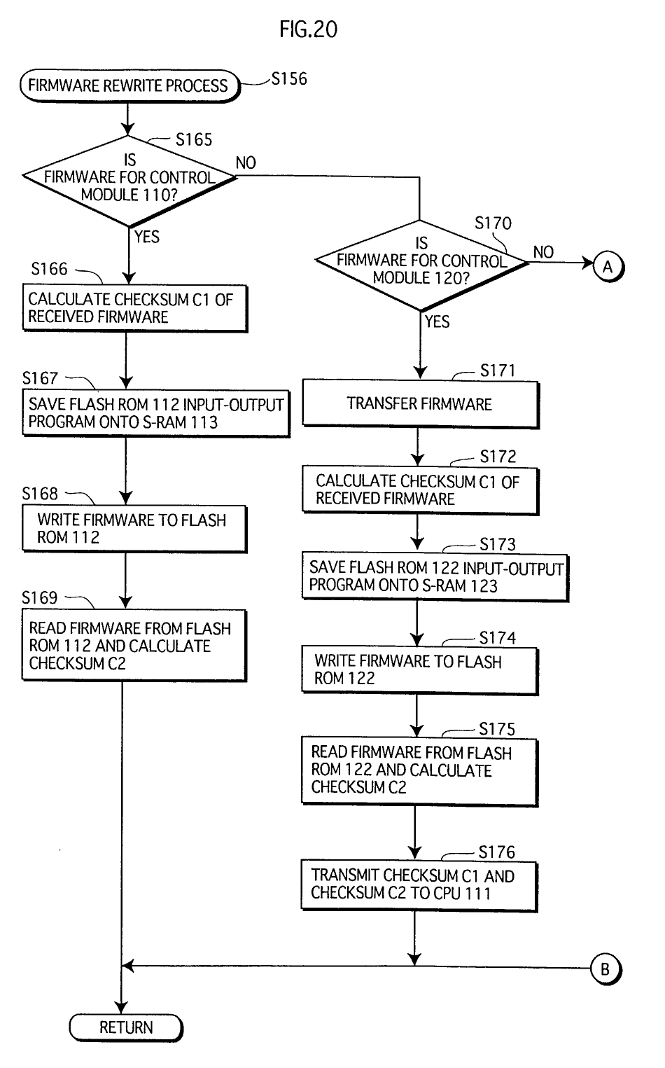

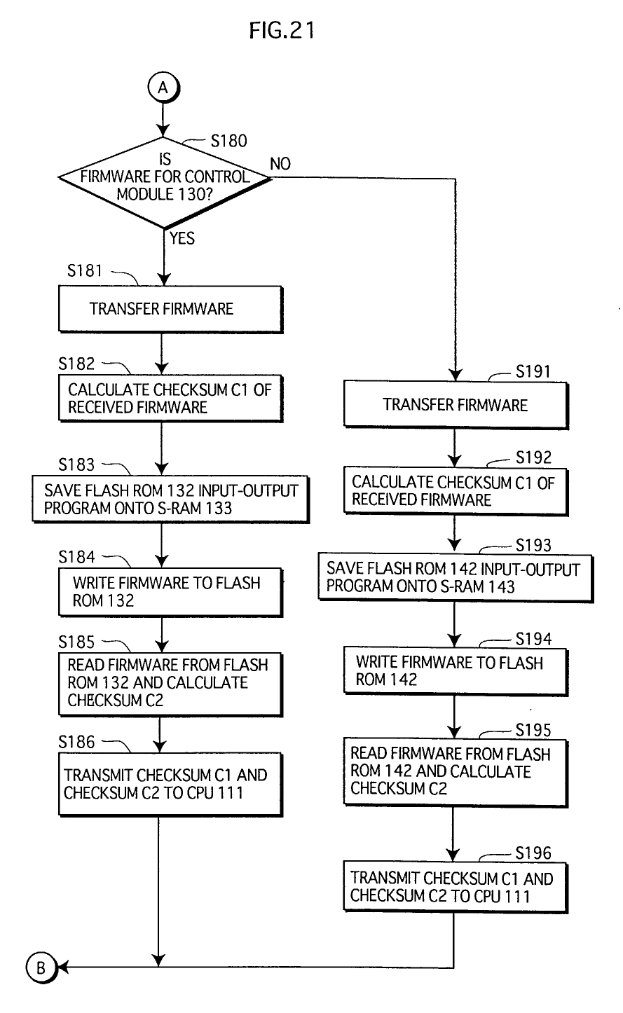

FIGS. 20 and 21 are flowcharts showing the firmware rewrite process executed in the image forming apparatus 1. The CPU 111 judges whether data for received firmware is intended for the control module 110 or not (step S165).

When judging that the received firmware data is intended for the control module 110, the CPU 111 calculates a checksum of the received firmware data, and stores its result (hereafter referred to as a “checksum C1”) into the S-RAM 113 (step S165;YES, step S166).

Following this, the CPU 111 saves an input-output program in the flash ROM 112 onto the S-RAM 113, and writes the received firmware data to the flash ROM 112 (steps S167 and S168). When completing the writing, the CPU 111 reads firmware data newly written to the flash ROM 112, and calculates a checksum of the read firmware data (its result is referred to as a “checksum C2”) (step S169), and ends the process.

When judging that the received firmware data is not intended for the control module 110, the CPU 111 judges whether the received firmware data is intended for the control module 120 or not (step S165;NO, step S170).

When judging that the received firmware data is intended for the control module 120, the CPU 111 transfers the firmware data to the control module 120. The CPU 121 calculates a checksum of the firmware data, and stores its result into the S-RAM 123 (step S170;YES, steps S171 and S172).

Following this, the CPU 121 saves an input-output program in the flash ROM 122 onto the S-RAM 123, and writes the received firmware data to the flash ROM 122 (steps S173 and S174)

When completing the writing, the CPU 121 reads firmware data newly written to the flash ROM 122, and calculates a checksum of the read firmware data (step S175). The CPU 121 transmits the checksum C1 and the checksum C2 to the CPU 111 (step S176), and ends the process.

When judging that the received firmware data is not intended for the control module 120, referring now to FIG. 21, the CPU 111 judges whether the received firmware data is intended for the control module 130 or not (step S170;NO, step S180).

When judging that the received firmware data is intended for the control module 130, the CPU 111 transfers the firmware data to the control module 130. The CPU 131 calculates a checksum of the firmware data, and stores its result into the S-RAM 133 (step S180;YES, steps S181 and S182).

Following this, the CPU 131 saves an input-output program in the flash ROM 132 onto the S-RAM 133, and writes the received firmware data to the flash ROM 132 (steps S183 and S184)

When completing the writing, the CPU 131 reads firmware data newly written to the flash ROM 132, and calculates a checksum of the read firmware data (step S185). The CPU 131 transmits the checksum C1 and the checksum C2 to the CPU 111 (step S186), and ends the process.

When judging that the received firmware data is not intended for the control module 130, the CPU 111 transfers the firmware data to the control module 140. The CPU 141 calculates a checksum of the firmware data, and stores its result into the S-RAM 143 (steps S191 and S192).

Following this, the CPU 141 saves an input-output program in the flash ROM 142 onto the S-RAM 143, and writes the received firmware data to the flash ROM 142 (steps S193 and S194).

When completing the writing, the CPU 141 reads firmware data newly written to the flash ROM 142, and calculates a checksum of the read firmware data (step S195). The CPU 141 transmits the checksum C1 and the checksum C2 to the CPU 111 (step S196), and ends the process.

With the construction described above, such a case can be avoided where a request for management information is transmitted from the management apparatus 4 to the image forming apparatus 1 while the image forming apparatus 1 is executing rewrite of firmware. Due to this, it is ensured that the image forming apparatus 1 can respond to a request for management information transmitted from the management apparatus 4.

Although the present invention has been described based on the above embodiment, it should be clear that the present invention is not limited to specific examples shown in the above embodiment. For example, the following modifications are possible.

(1) The above embodiment describes the case where the print controller 2 manages print jobs received from the client apparatus 5-x, checks whether an e-mail message transmitted from the central management apparatus at the service center is present or not, transmits firmware and instructs rewrite to the firmware, responds to a management information request transmitted from the management apparatus 4, and so forth. However, the print controller 2 may not necessarily perform all of such operations.

For example, the image forming apparatus 1 may directly receive an e-mail message transmitted from the central management apparatus 91, download the e-mail message, obtain firmware from the e-mail message, and store the firmware, and the print controller 2 may only instruct the image forming apparatus 1 to execute rewrite to the obtained firmware at a certain timing.

In this case, the image forming apparatus 1 may notify the print controller 2 that the image forming apparatus 1 has obtained firmware. As in the above embodiment, the print controller 2 may judge whether a management information request is scheduled to be transmitted while the image forming apparatus 1 is executing rewrite to the firmware or not. When judging that a management information request is scheduled to be transmitted during such a time period, the print controller 2 may transmit, to the management apparatus 4, a request to change the management information request interval. On the contrary, alternatively, the print controller 2 may manage not only print jobs but also copy jobs.

(2) Although the above embodiment describes the case where the image forming apparatus 1 and the print controller 2 are separately provided, the print controller 2 and the image forming apparatus 1 may be integrated as one apparatus. In this case, the control functions of the CPU 201 in the print controller 2 may be additionally provided to the control module 110 in the image forming apparatus 1. Alternatively, a new control module, e.g., a control module 150, that has the same control functions as the print controller 2 may be provided.

(3) Although the above embodiment describes the case where the management apparatus 4 is connected to the LAN 3 as being separate from the client apparatus 5-x, the client apparatus 5-x may be provided with the management functions of the management apparatus 4, and the client apparatus 5-x with such management functions may transmit a request for management information to the print controller 2.

(4) The above embodiment describes the case where the management information request interval is changed so as to avoid such a case where a management information request is transmitted from the management apparatus 4 while rewrite of firmware is being executed. However, instead of changing the management information request interval to avoid such a case, a management information request may be prohibited from being transmitted when the management information request is scheduled to be transmitted from the management apparatus 4 while rewrite of firmware is being executed.

In this case, the print controller 2 may transmit, to the management apparatus 4, a start notification when starting the rewrite of firmware, and a completion notification when completing the rewrite of firmware. The management apparatus 4 may suspend transmission of a management information request once receiving the start notification, and may resume transmission of a management information request once receiving the completion notification.

Accordingly, in the present invention, suspending transmission of a management information request intends to include not only the concept of changing a management information request interval but also the concept of not generating a management information request and the concept of not transmitting a management information request.

(5) Although the above embodiment is described taking management and monitoring of the image forming apparatus 1 in the network using SNMP for example, the image forming apparatus 1 may be provided with a WWW server, and a management information request may be transmitted from the management apparatus 4 or a browser of the client apparatus 5-x, management information may be transmitted in the form of an HTML file or the like, to the management apparatus 4 or to the client apparatus 5-x. Also, a protocol other than SNMP protocol may instead be used.

(6) Although the above embodiment describes the case where the print controller 2 obtains (or has the function of receiving) a management information request interval from the management apparatus 4, the print controller 2 may calculate a timing at which a management information request is scheduled to be transmitted next, based on a past reception interval at which a management information request has been received.

Also, the management apparatus 4 may notify in advance the print controller 2 of a transmission schedule to transmit a management information request, e.g., a timing at which a management information request is scheduled to be transmitted, and the like, as table data. According to a rewrite time period required for rewrite to firmware, the print controller 2 may transmit a request to change a timing at which a management information request is transmitted, based on the table data. Because the transmission schedule to transmit a management information request is provided in advance, a management information request that is transmitted irregularly can also be covered by the present invention.

(7) Although the above embodiment describes the case where the print controller 2 transmits, to the management apparatus 4, a request to change a management information request interval, the print controller 2 may calculate a completion time at which rewrite to firmware is completed, based on a rewrite time period required for the rewrite to firmware and the present time, and may notify the management apparatus 4 that a management information request is not to be transmitted until the completion time comes.

(8) The above embodiment describes the case where a judgment as to whether a management information request is scheduled to be transmitted during rewrite of firmware or not, by judging whether a management information request interval is equal to or less than a firmware rewrite time period or not. However, because the firmware rewrite time period is generally longer than the management information request interval, the judgment as to whether a management information request is scheduled to be transmitted during rewrite of firmware may not be performed. In this case, when an instruction to execute rewrite of firmware is issued, the firmware rewrite time period may be calculated and the management information request interval may be changed to a new management information request interval that is longer than the calculated firmware rewrite time period.

(9) Although the above embodiment is described taking the image forming apparatus 1 that can execute a copy job and a print job for example, the present invention can be applied to an image processing apparatus, such as a facsimile and a network scanner, that can also execute other jobs. In this case, the image processing apparatus may include four or more control modules, or may include a smaller number of control modules by combining the above four control modules.

(10) The above embodiment describes the case where the print controller 2 changes the new management information request interval back to the request interval used before rewrite of firmware, when receiving a signal (notification) indicating a firmware rewrite completion from the image forming apparatus 1. However, the print controller 2 may change the new management information request interval back to the request interval used before rewrite of firmware, when a predictive firmware rewrite time period has elapsed since the print controller 2 instructed the image forming apparatus 1 to execute the rewrite of firmware.

Also, when receiving, from the print controller 2, a request to change the management information request interval, the management apparatus 4 may store the present management information request interval before the change is made. The management apparatus 4 may transmit a management information request at a received new management information request interval, and then, may change the new management information request interval back to the management information request interval stored therein before the change is made. By doing so, the management burden on the print controller 2 can be reduced.

(11) Although the above embodiment describes the case where a computer of the print controller 2 connected to the image forming apparatus 1 executes a program of the present invention, the program of the present invention is recorded on a computer-readable recording medium.

(12) In the above embodiment, a “processing request of management information from a management terminal” of the present invention specifically means that the management apparatus 4 transmits, to the print controller 2, a request to execute a process of transmitting management information collected from the image forming apparatus 1. A “predetermined response process” of the present invention specifically means that the print controller 2 collects management information of the image forming apparatus 1 and transmits the collected management information to the management apparatus 4. However, the contents of the “processing request of management information from the management terminal” of the present invention and the “predetermined response process” of the present invention may be other than the above-described contents.

To be more specific, the following response process maybe employed. The management apparatus 4 transmits a request to change management information held by the image forming apparatus 1, to the print controller 2. In response to this request, the print controller 2 instructs the image forming apparatus 1 to change management information. Upon receipt of a message indicating that the change in the management information is completed from the image forming apparatus 1, the print controller 2 notifies the management apparatus 4 of the change completion.

As an example of this request to change management information, a request to regularly change print job management information may be transmitted from the management apparatus 4 to the image forming apparatus 1, so as to manage print jobs. As this example, a job processing mode may be regularly changed to a mode requested by the management apparatus 4, or may be regularly, changed to a job completion notification mode to make the image processing apparatus 1 transmit a job completion notification.

Further, the contents of the “processing request for management information from the management terminal” of the present invention and the “predetermined response process” of the present invention may be both the contents of the “request for management information” and the “response process of transmitting management information” described in the above embodiment and the contents of the “request to change management information” and the “process of changing management information” described in the present modification example, or may be combinations of those contents.

(13) Although in the above modification example (12), the management apparatus 4 as a management terminal transmits a request to change management information to the print controller 2, the client apparatus 5-x as a management apparatus may instead transmit a request to regularly change print job management information to the print controller 2.

To be more specific, the client apparatus 5-x may regularly transmit information indicating that a print job is scheduled or not, to the print controller 2. When a print job is scheduled, the print controller 2 may change management information to schedule the print job and reserve a resource for the print job, and transmit the result to the client apparatus 5-x.

It should be noted here that reserving a resource indicates to prohibit reception of other print jobs while the print job for which the resource is reserved is being executed, indicates to reserve a memory space corresponding to a data size of the print job or a recording sheet to be used, and so forth.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image processing apparatus that executes a predetermined process in response to a request for management information that is transmitted from a management terminal, the image processing apparatus comprising:
a memory storing firmware;
an image processing job execution controller for executing an image processing job based on the firmware;
a firmware obtaining unit for obtaining new firmware for a rewrite purpose;
a firmware rewrite controller for rewriting the firmware stored in the memory to the obtained new firmware; and
a notification controller for notifying the management terminal that transmission of the management information request is to be suspended while the firmware rewrite controller is rewriting the firmware stored in the memory to the obtained new firmware.

2. The image processing apparatus of claim 1,
wherein the notification controller notifies the management terminal that transmission of the management information request is to be performed at times except while the firmware rewrite controller is rewriting the firmware stored in the memory to the obtained new firmware.

3. The image processing apparatus of claim 2,
wherein the notification controller notifies the management terminal that a request interval at which the management information request is transmitted is to be changed to a new request interval.

4. The image processing apparatus of claim 3, further comprising:
a time calculation unit for calculating a rewrite time period that is to be required for rewriting the firmware stored in the memory to the obtained new firmware; and
an interval determination unit for determining the new request interval, based on the calculated rewrite time period, in such a manner that the management information request is not transmitted while the firmware rewrite controller is rewriting the firmware stored in the memory to the obtained new firmware,
wherein the notification controller notifies the management terminal that the request interval is to be changed to the new request interval determined by the interval determination unit.

5. The image processing apparatus of claim 4, further comprising:
a transmission schedule obtaining unit for obtaining information about a transmission schedule for the management terminal to transmit the management information request; and
a judgment unit for judging whether the management information request is scheduled to be transmitted while the firmware rewrite controller is rewriting the firmware stored in the memory to the obtained new firmware, based on the rewrite time period and the obtained information about the transmission schedule,
wherein the interval determination unit determines the new request interval so as to be longer than the rewrite time period, when the judgment unit judges that the management information request is scheduled to be transmitted while the firmware rewrite controller is rewriting the firmware stored in the memory to the obtained new firmware.

6. The image processing apparatus of claim 4,
wherein the rewrite time period calculated by the time calculation unit includes at least (a) a rewrite processing time period that is calculated based on a size of the new firmware and (b) an initialization time period that is required for rebooting the image processing apparatus.

7. The image processing apparatus of claim 3,
wherein the notification controller notifies the management terminal that the new request interval is to be changed back to the request interval used before change.

8. The image processing apparatus of claim 1,
wherein the image processing apparatus is connected to the Internet, and
the new firmware for a rewrite purpose is distributed via the Internet as being attached to an e-mail message.

9. The image processing apparatus of claim 1,
wherein the image processing apparatus includes a printer, and
the image processing job includes a print job.

10. A management unit that is connected to an image processing apparatus and that executes a predetermined process required for managing the image processing apparatus in response to a request for management information that is transmitted from a management terminal, the management unit comprising:
an instruction controller for instructing the image processing apparatus to rewrite existing firmware to new firmware; and
a notification controller for notifying the management terminal that transmission of the management information request is to be suspended while the image processing apparatus is rewriting the existing firmware to the new firmware.

11. The management unit of claim 10,
wherein the notification controller notifies the management terminal that transmission of the management information request is to be performed at times except while the image processing apparatus is rewriting the existing firmware to the new firmware.

12. The management unit of claim 11,
wherein the notification controller notifies the management terminal that a request interval at which the management information request is transmitted is to be changed to a new request interval.

13. The management unit of claim 12, further comprising:
a time calculation unit for calculating a rewrite time period that is to be required by the image processing apparatus for rewriting the existing firmware to the new firmware; and
an interval determination unit for determining the new request interval, based on the calculated rewrite time period, in such a manner that the management information request is not transmitted while the image processing apparatus is rewriting the existing firmware to the new firmware,
wherein the notification controller notifies the management terminal that the request interval is to be changed to the new request interval determined by the interval determination unit.

14. The management unit of claim 13, further comprising:
a transmission schedule obtaining unit for obtaining information about a transmission schedule for the management terminal to transmit the management information request; and
a judgment unit for judging whether the management information request is scheduled to be transmitted while the image processing apparatus is rewriting the existing firmware to the new firmware, based on the rewrite time period and the obtained information about the transmission schedule,
wherein the interval determination unit determines the new request interval so as to be longer than the rewrite time period, when the judgment unit judges that the management information request is scheduled to be transmitted while the image processing apparatus is rewriting the existing firmware to the new firmware.

15. The management unit of claim 13,
wherein the rewrite time period calculated by the time calculation unit includes at least (a) a rewrite processing time period that is calculated based on a size of the new firmware and (b) an initialization time period that is required for rebooting the image processing apparatus.

16. The management unit of claim 12,
wherein the notification controller notifies the management terminal that the new request interval is to be changed back to the request interval used before change.

17. A program that is executed by a computer of an image processing apparatus for executing a predetermined process in response to a request for management information that is transmitted from a management terminal, the program comprising the steps of:
obtaining firmware that is necessary for image processing;
instructing to rewrite existing firmware to the obtained firmware; and
notifying the management terminal that transmission of the management information request is to be suspended while the existing firmware is being rewritten to the obtained firmware.
